(19) United States
(12) Patent Application Publication
(10) Pub. No.: US 2024/0372119 A1
(43) Pub. Date: Nov. 7, 2024

(54) FUEL CELL SYSTEMS AND METHODS OF SIZING AND OPERATING AN EJECTOR BY USING A BY-PASS VALVE

(71) Applicant: CUMMINS INC., Columbus, IN (US)

(72) Inventor: Richard J. ANCIMER, Toronto, ON (CA)

(21) Appl. No.: 18/572,338

(22) PCT Filed: Jun. 20, 2022
(86) PCT No.: PCT/US2022/034168

§ 371 Date: Dec. 20, 2023

Related U.S. Application Data
(60) Provisional application No. 63/215,077, filed on Jun. 25, 2021.

(51) Int. Cl. H01M 8/04089; H01M 8/04082; H01M 8/04746; H01M 8/04791; H01M 8/10

(52) U.S. Cl. CPC H01M 8/04089; H01M 8/04201; H01M 8/04753; H01M 8/04798; H01M 2008/1095; H01M 2250/20

(57) ABSTRACT

The present disclosure generally relates to fuel cell systems and methods of sizing a venturi or ejector by using aby-pass valve for determining or controlling fuel flow through the venturi or ejector.

### CROSS-REFERENCE TO RELATED APPLICATIONS

This nonprovisional application claims the benefit and priority, under 35 U.S.C. § 119(e) and any other applicable laws or statutes, to U.S. Provisional Patent Application Ser. No. 63/215,077 filed on Jun. 25, 2021, the entire disclosure of which is hereby expressly incorporated herein by reference.

### TECHNICAL FIELD

The present disclosure relates to systems and methods of sizing and operating a venturi or ejector in a fuel cell, fuel cell stack, and/or fuel cell system by using a by-pass valve..

### BACKGROUND

Vehicles and/or powertrains use fuel cells or fuel cell stacks for their power needs.

The present disclosure relates to systems and methods of sizing and operating a venturi or ejector in the fuel cell system by using a by-pass valve for determining/controlling fuel flow through the venturi or ejector More specifically, the present disclosure relates to appropriately sizing the venturi or ejector, configuring and operating the by-pass valve to enable the fuel cell system to attain the target primary fuel flow rate and entrainment ratio (ER) across a wide operating range.

### SUMMARY

Embodiments of the present invention are included to meet these and other needs.

In one aspect of the present disclosure, described herein, a fuel cell or fuel stack system includes a first fuel and a second fuel. The first fuel flows through a control valve and a sized ejector. The second fuel flows through a control valve and a by-pass valve. The sized ejector and the by-pass valve are in a parallel configuration.

In some embodiments, the by-pass valve may be a proportionally controlled valve.

In some embodiments, the sized ejector may include a primary nozzle. A size of the sized ejector may be determined by decreasing the primary nozzle area.

In some embodiments, the by-pass valve may have a variable opening or closing inner valve that may determine the second fuel flowing through the by-pass valve.

In some embodiments, the by-pass valve may be sized to allow both the first fuel and the second fuel to flow through the by-pass valve.

In some embodiments, a size of the sized ejector may be determined based on an effective efficiency of the sized ejector, geometry of the sized ejector or operational conditions of the system.

In some embodiments, a size of the sized ejector may be determined based on a composition of the first fuel or a composition of the second fuel.

In a second aspect of the present disclosure, a method of using a fuel cell or fuel stack system includes the steps of flowing a first fuel through a sized ejector and flowing a second fuel through a by-pass valve. The sized ejector and the by-pass valve are in a parallel configuration.

In some embodiments, the by-pass valve may be a proportionally controlled valve.

In some embodiments, the sized ejector may include a primary nozzle. A size of the sized ejector may be determined by decreasing the primary nozzle area.

In some embodiments, the by-pass valve may have a variable opening or closing inner valve that may determine the second fuel flowing through the by-pass valve.

In some embodiments, the by-pass valve may be sized to allow both the first fuel and the second fuel to flow through the by-pass valve.

In some embodiments, a size of the sized ejector may be determined based on an effective efficiency of the sized ejector, geometry of the sized ejector or operational conditions of the system.

In some embodiments, a size of the sized ejector may be determined based on a composition of the first fuel or a composition of the second fuel.

### BRIEF DESCRIPTION OF THE DRAWINGS

These and other features, aspects, and advantages of the present invention will become better understood when the following detailed description is read with reference to the accompanying drawings, in which like characters represent like parts throughout the drawings, wherein:

FIG. 1A is an illustration of a fuel cell system including one or more fuel cell stacks connected to a balance of plant.

FIG. 1B is an illustration showing a fuel cell module and a fuel cell system comprising a fuel cell and/or a fuel cell stack.

FIG. 1C is an illustration of components of a fuel cell in the fuel cell stack.

FIG. 2 is a graph showing the operating curves of a system comprising a fuel cell or fuel cell stack.

FIG. 3 is a schematic showing a mechanical regulator used along with a venturi or ejector in a fuel cell stack system.

FIG. 4 is a schematic showing a proportional control valve used along with a venturi or ejector in a fuel cell stack system.

FIG. 5 is a schematic showing a flow restriction used along with a venturi or ejector in a fuel cell stack system.

FIG. 6 is a schematic showing the different regions in a mixer.

FIG. 7 is a schematic showing the entry of the motive flow (primary flow) and the entrained flow (secondary flow) in a venturi or ejector.

FIG. 8 is a graph showing the entrainment ratio (ER), the critical entrainment ratio (ER__{critical}), the target entrainment ratio (ER__{target}), and the reversible entrainment ratio of the system for about a 60% internal ejector efficiency as function of current density.

FIG. 9 is a graph showing that a system may not be able to extend operation below a certain current density for the given operating conditions even with a 100% internal ejector efficiency.

FIG. 10A is a graph showing the system entrainment ratio in a system comprising an EES configuration with an EES size of 1.0, a maximum pressure lift (ΔP_{LIFT}) of about 0.15 bara, a large mixer area ratio (MAR) value such that geometric restriction may not apply to the system, an internal ejector efficiency of about 60%, and a binary by-pass valve or flow restriction.

FIG. 10B is a graph showing the ejector entrainment ratio (ER) in a system comprising an EES configuration with an EES size of 1.0, a maximum pressure lift (ΔP_{LIFT}) of about 0.15 bara, a large mixer area ratio (MAR) value such that geometric restriction may not apply to the system, an internal ejector efficiency of about 60%, and a binary by-pass valve or flow restriction.

FIG. 10C is a graph showing the ratio of the entrainment ratio to the target entrainment ratio in a system comprising an EES configuration with an EES size of 1.0, a maximum pressure lift (ΔP_{LIFT}) of about 0.15 bara, a large mixer area ratio (MAR) value such that geometric restriction may not apply to the system, an internal ejector efficiency of about 60%, and a binary by-pass valve or flow restriction.

FIG. 10D is a graph showing the ratio of the entrainment ratio to the reversible entrainment ratio in a system comprising an EES configuration with an EES size of 1.0, a maximum pressure lift (ΔP_{LIFT}) of about 0.15 bara, a large mixer area ratio (MAR) value such that geometric restriction may not apply to the system, an internal ejector efficiency of about 60%, and a binary by-pass valve or flow restriction.

FIG. 11A is a graph showing the system entrainment ratio in a system comprising an EES configuration with an EES size of 0.21, a maximum pressure lift (ΔP_{LIFT}) of about 0.15 bara, a large mixer area ratio (MAR) value such that geometric restriction may not apply to the system, an internal ejector efficiency of about 60%, and a binary by-pass valve or flow restriction.

FIG. 11B is a graph showing the ejector entrainment ratio (ER) in a system comprising an EES configuration with an EES size of 0.21, a maximum pressure lift (ΔP_{LIFT}) of about 0.15 bara, a large mixer area ratio (MAR) value such that geometric restriction may not apply to the system, an internal ejector efficiency of about 60%, and a binary by-pass valve or flow restriction.

FIG. 11C is a graph showing the ratio of the entrainment ratio to the target entrainment ratio in a system comprising an EES configuration with an EES size of 0.21, a maximum pressure lift (ΔP_{LIFT}) of about 0.15 bara, a large mixer area ratio (MAR) value such that geometric restriction may not apply to the system, an internal ejector efficiency of about 60%, and a binary by-pass valve or flow restriction.

FIG. 11D is a graph showing the ratio of the entrainment ratio to the reversible entrainment ratio in a system comprising an EES configuration with an EES size of 0.21, a maximum pressure lift (ΔP_{LIFT}) of about 0.15 bara, a large mixer area ratio (MAR) value such that geometric restriction may not apply to the system, an internal ejector efficiency of about 60%, and a binary by-pass valve or flow restriction.

FIG. 12A is a graph showing the system entrainment ratio in a system comprising an EES configuration with an EES size of 0.21, a maximum pressure lift (ΔP_{LIFT}) of about 0.15 bara, a large mixer area ratio (MAR) value such that geometric restriction may not apply to the system, an internal ejector efficiency of about 60%, and a by-pass valve or flow restriction set such that flow through the venturi or ejector is maximized.

FIG. 12B is a graph showing the ejector entrainment ratio (ER) in a system comprising an EES configuration with an EES size of 0.21, a maximum pressure lift (ΔP_{LIFT}) of about 0.15 bara, a large mixer area ratio (MAR) value such that geometric restriction may not apply to the system, an internal ejector efficiency of about 60%, and a by-pass valve or flow restriction set such that flow through the venturi or ejector is maximized.

FIG. 12C is a graph showing the ratio of the entrainment ratio to the target entrainment ratio in a system comprising an EES configuration with an EES size of 0.21, a maximum pressure lift (ΔP_{LIFT}) of about 0.15 bara, a large mixer area ratio (MAR) value such that geometric restriction may not apply to the system, an internal ejector efficiency of about 60%, and a by-pass valve or flow restriction set such that flow through the venturi or ejector is maximized.

FIG. 12D is a graph showing the ratio of the entrainment ratio to the reversible entrainment ratio in a system comprising an EES configuration with an EES size of 0.21, a maximum pressure lift (ΔP_{LIFT}) of about 0.15 bara, a large mixer area ratio (MAR) value such that geometric restriction may not apply to the system, an internal ejector efficiency of about 60%, and a by-pass valve or flow restriction set such that flow through the venturi or ejector is maximized.

FIG. 13A is a graph showing the system entrainment ratio in a system comprising an EES configuration with an EES size of 0.21, a maximum pressure lift (ΔP_{LIFT}) of about 0.15 bara, a large mixer area ratio (MAR) value such that geometric restriction may not apply to the system, an internal ejector efficiency of about 60%, and a proportional control valve used as by-pass valve or flow restriction.

FIG. 13B is a graph showing the ejector entrainment ratio (ER) in a system comprising an EES configuration with an EES size of 0.21, a maximum pressure lift (ΔP_{LIFT}) of about 0.15 bara, a large mixer area ratio (MAR) value such that geometric restriction may not apply to the system, an internal ejector efficiency of about 60%, and a proportional control valve used as by-pass valve or flow restriction.

FIG. 13C is a graph showing the ratio of the entrainment ratio to the target entrainment ratio in a system comprising an EES configuration with an EES size of 0.21, a maximum pressure lift (ΔP_{LIFT}) of about 0.15 bara, a large mixer area ratio (MAR) value such that geometric restriction may not apply to the system, an internal ejector efficiency of about 60%, and a proportional control valve used as by-pass valve or flow restriction.

FIG. 13D is a graph showing the ratio of the entrainment ratio to the reversible entrainment ratio in a system comprising an EES configuration with an EES size of 0.21, a maximum pressure lift (ΔP_{LIFT}) of about 0.15 bara, a large mixer area ratio (MAR) value such that geometric restriction may not apply to the system, an internal ejector efficiency of about 60%, and a proportional control valve used as by-pass valve or flow restriction.

FIG. 14A is a graph showing the system entrainment ratio in a system comprising an EES configuration with an EES size of 1.0, a maximum pressure lift (ΔP_{LIFT}) of about 0.25 bara, a large mixer area ratio (MAR) value such that geometric restriction may not apply to the system, an internal ejector efficiency of about 50%, and a binary by-pass valve or flow restriction.

FIG. 14B is a graph showing the ejector entrainment ratio (ER) in a system comprising an EES configuration with an EES size of 1.0, a maximum pressure lift (ΔP_{LIFT}) of about 0.25 bara, a large mixer area ratio (MAR) value such that geometric restriction may not apply to the system, an internal ejector efficiency of about 50%, and a binary by-pass valve or flow restriction.

FIG. 14C is a graph showing the ratio of the entrainment ratio to the target entrainment ratio in a system comprising an EES configuration with an EES size of 1.0, a maximum pressure lift (ΔP_{LIFT}) of about 0.25 bara, a large mixer area ratio (MAR) value such that geometric restriction may not apply to the system, an internal ejector efficiency of about 50%, and a binary by-pass valve or flow restriction.

FIG. 14D is a graph showing the ratio of the entrainment ratio to the reversible entrainment ratio in a system comprising an EES configuration with an EES size of 1.0, a maximum pressure lift (ΔP_{LIFT}) of about 0.25 bara, a large mixer area ratio (MAR) value such that geometric restriction may not apply to the system, an internal ejector efficiency of about 50%, and a binary by-pass valve or flow restriction.

FIG. 15A is a graph showing the system entrainment ratio in a system comprising an EES configuration with an EES size of 0.27, a maximum pressure lift (ΔP_{LIFT}) of about 0.25 bara, a large mixer area ratio (MAR) value such that geometric restriction may not apply to the system, an internal ejector efficiency of about 50%, and a binary by-pass valve or flow restriction.

FIG. 15B is a graph showing the ejector entrainment ratio (ER) in a system comprising an EES configuration with an EES size of 0.27, a maximum pressure lift (ΔP_{LIFT}) of about 0.25 bara, a large mixer area ratio (MAR) value such that geometric restriction may not apply to the system, an internal ejector efficiency of about 50%, and a binary by-pass valve or flow restriction.

FIG. 15C is a graph showing the ratio of the entrainment ratio to the target entrainment ratio in a system comprising an EES configuration with an EES size of 0.27, a maximum pressure lift (ΔP_{LIFT}) of about 0.25 bara, a large mixer area ratio (MAR) value such that geometric restriction may not apply to the system, an internal ejector efficiency of about 50%, and a binary by-pass valve or flow restriction.

FIG. 15D is a graph showing the ratio of the entrainment ratio to the reversible entrainment ratio in a system comprising an EES configuration with an EES size of 0.27, a maximum pressure lift (ΔP_{LIFT}) of about 0.25 bara, a large mixer area ratio (MAR) value such that geometric restriction may not apply to the system, an internal ejector efficiency of about 50%, and a binary by-pass valve or flow restriction.

FIG. 16A is a graph showing the system entrainment ratio in a system comprising an EES configuration with an EES size of 0.27, a maximum pressure lift (ΔP_{LIFT}) of about 0.25 bara, a large mixer area ratio (MAR) value such that geometric restriction may not apply to the system, an internal ejector efficiency of about 50%, and a by-pass valve or flow restriction set such that flow through the venturi or ejector is maximized.

FIG. 16B is a graph showing the ejector entrainment ratio (ER) in a system comprising an EES configuration with an EES size of 0.27, a maximum pressure lift (ΔP_{LIFT}) of about 0.25 bara, a large mixer area ratio (MAR) value such that geometric restriction may not apply to the system, an internal ejector efficiency of about 50%, and a by-pass valve or flow restriction set such that flow through the venturi or ejector is maximized.

FIG. 16C is a graph showing the ratio of the entrainment ratio to the target entrainment ratio in a system comprising an EES configuration with an EES size of 0.27, a maximum pressure lift (ΔP_{LIFT}) of about 0.25 bara, a large mixer area ratio (MAR) value such that geometric restriction may not apply to the system, an internal ejector efficiency of about 50%, and a by-pass valve or flow restriction set such that flow through the venturi or ejector is maximized.

FIG. 16D is a graph showing the ratio of the entrainment ratio to the reversible entrainment ratio in a system comprising an EES configuration with an EES size of 0.27, a maximum pressure lift (ΔP_{LIFT}) of about 0.25 bara, a large mixer area ratio (MAR) value such that geometric restriction may not apply to the system, an internal ejector efficiency of about 50%, and a by-pass valve or flow restriction set such that flow through the venturi or ejector is maximized.

FIG. 17A is a graph showing the system entrainment ratio in a system comprising an ES configuration with an EES size of 0.27, a maximum pressure lift (ΔP_{LIFT}) of about 0.25 bara, a large mixer area ratio (MAR) value such that geometric restriction may not apply to the system, an internal ejector efficiency of about 50%, and a proportional control valve used as by-pass valve or flow restriction.

FIG. 17B is a graph showing the ejector entrainment ratio (ER) in a system comprising an EES configuration with an EES size of 0.27, a maximum pressure lift (ΔP_{LIFT}) of about 0.25 bara, a large mixer area ratio (MAR) value such that geometric restriction may not apply to the system, an internal ejector efficiency of about 50%, and a proportional control valve used as by-pass valve or flow restriction.

FIG. 17C is a graph showing the ratio of the entrainment ratio to the target entrainment ratio in a system comprising an EES configuration with an EES size of 0.27, a maximum pressure lift (ΔP_{LIFT}) of about 0.25 bara, a large mixer area ratio (MAR) value such that geometric restriction may not apply to the system, an internal ejector efficiency of about 50%, and a proportional control valve used as by-pass valve or flow restriction.

FIG. 17D is a graph showing the ratio of the entrainment ratio to the reversible entrainment ratio in a system comprising an EES configuration with an EES size of 0.27, a maximum pressure lift (ΔP_{LIFT}) of about 0.25 bara, a large mixer area ratio (MAR) value such that geometric restriction may not apply to the system, an internal ejector efficiency of about 50%, and a proportional control valve used as by-pass valve or flow restriction.

### DETAILED DESCRIPTION

The present disclosure relates to sizing a venturi or an ejector such that a fuel cell system comprising the venturi or ejector can attain a target entrainment ratio (ER). The present disclosure relates to fuel cell systems and methods of using a by-pass valve for determining and/or controlling fuel flow through the venturi or ejector sized to attain the target entrainment ratio based on operational conditions and/or requirements of the fuel cell system.

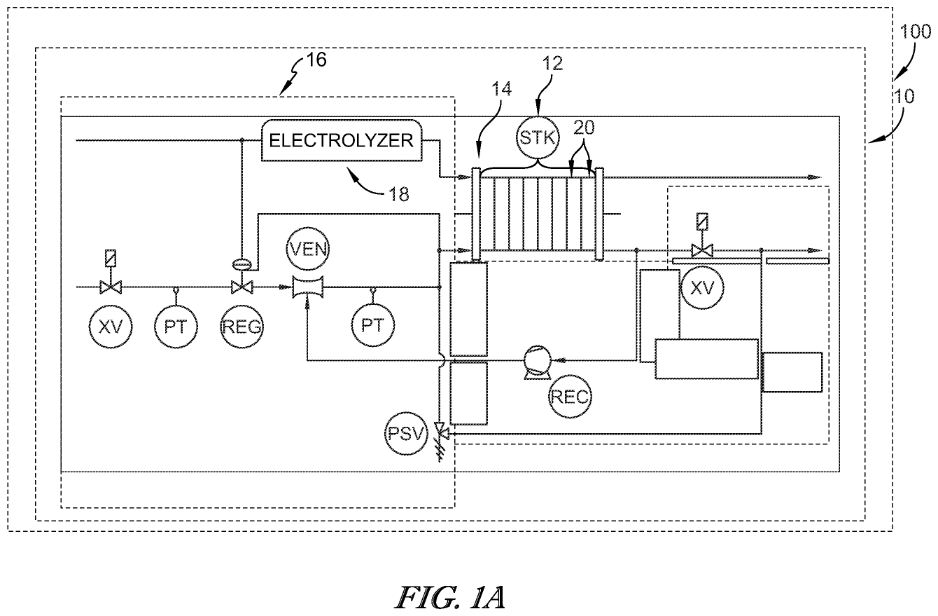

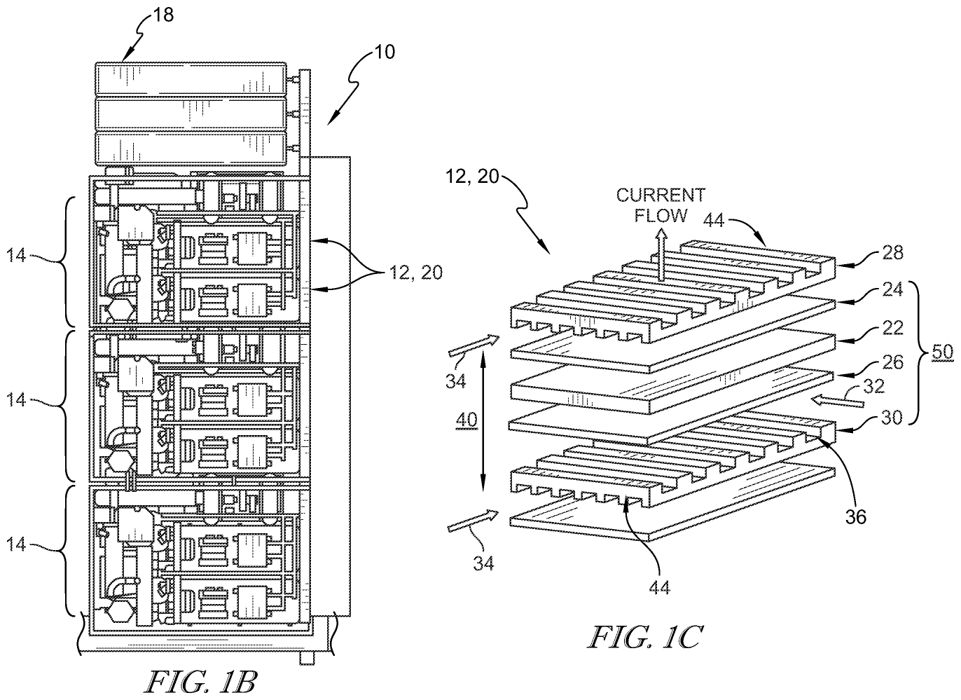

As shown in FIG. 1A, fuel cell systems or fuel cell stack systems 10 often include one or more fuel cell stacks 12 or fuel cell modules 14 connected to a balance of plant (BOP) 16, including various components, to create, generate, and/or distribute electrical power for meet modern day industrial and commercial needs in an environmentally friendly way. As shown in FIGS. 1B and 1C, fuel cell systems 10 may include fuel cell stacks 12 comprising a plurality of individual fuel cells 20. Each fuel cell stack 12 may house a plurality of fuel cells 20 connected together in series and/or in parallel. The fuel cell system 10 may include one or more fuel cell modules 14 as shown in FIGS. 1A and 1B. Each fuel cell module 14 may include a plurality of fuel cell stacks 12 and/or a plurality of fuel cells 20.

The fuel cells 20 in the fuel cell stacks 12 may be stacked together to multiply and increase the voltage output of a single fuel cell stack 12. The number of fuel cell stacks 12 in a fuel cell system 10 can vary depending on the amount of power required to operate the fuel cell system 10 and meet the power need of any load. The number of fuel cells 20 in a fuel cell stack 12 can vary depending on the amount of power required to operate the fuel cell system 10 including the fuel cell stacks 12.

The number of fuel cells 20 in each fuel cell stack 12 or fuel cell system 10 can be any number. For example, the number of fuel cells 20 in each fuel cell stack 12 may range from about 100 fuel cells to about 1000 fuel cells, including any specific number or range of number of fuel cells 20 comprised therein (e.g., about 200 to about 800). In an embodiment, the fuel cell system 10 may include about 20 to about 1000 fuel cells stacks 12, including any specific number or range of number of fuel cell stacks 12 comprised therein (e.g., about 200 to about 800). The fuel cells 20 in the fuel cell stacks 12 within the fuel cell module 14 may be oriented in any direction to optimize the operational efficiency and functionality of the fuel cell system 10.

The fuel cells 20 in the fuel cell stacks 12 may be any type of fuel cell 20. The fuel cell 20 may be a polymer electrolyte membrane or proton exchange membrane (PEM) fuel cell, an anion exchange membrane fuel cell (AEMFC), an alkaline fuel cell (AFC), a molten carbonate fuel cell (MCFC), a phosphoric acid fuel cell (PAFC), or a solid oxide fuel cell (SOFC). In an exemplary embodiment, the fuel cells 20 may be a polymer electrolyte membrane or proton exchange membrane (PEM) fuel cell or a solid oxide fuel cell (SOFC).

In an embodiment shown in FIG. 1C, the fuel cell stack 12 includes a plurality of proton exchange membrane (PEM) fuel cells 20. Each fuel cell 20 includes a single membrane electrode assembly (MEA) 22 and a gas diffusion layer (GDL) 24, 26 on either or both sides of the membrane electrode assembly (MEA) 22 (see FIG. 1C). The fuel cell 20 further includes a bipolar plate (BPP) 28, 30 on the external side of each gas diffusion layers (GDL) 24, 26. The above mentioned components, 22, 24, 26, 30 comprise a single repeating unit 50.

The bipolar plates (BPP) 28, 30 are responsible for the transport of reactants, such as fuel 32 (e.g., hydrogen) or oxidant 34 (e.g., oxygen, air), and cooling fluid 36 (e.g., coolant and/or water) in a fuel cell 20. The bipolar plate (BPP) 28, 30 can uniformly distribute reactants 32, 34 to an active area 40 of each fuel cell 20 through oxidant flow fields 42 and/or fuel flow fields 44. The active area 40, where the electrochemical reactions occur to generate electrical power produced by the fuel cell 20, is centered within the gas diffusion layer (GDL) 24, 26 and the bipolar plate (BPP) 28, 30 at the membrane electrode assembly (MEA) 22. The bipolar plate (BPP) 28, 30 are compressed together to isolate and/or seal one or more reactants 32 within their respective pathways, channels, and/or flow fields 42, 44 to maintain electrical conductivity, which is required for robust during fuel cell 20 operation.

The fuel cell system 10 described herein, may be used in stationary and/or immovable power system, such as industrial applications and power generation plants. The fuel cell system 10 may also be implemented in conjunction with electrolyzers 18 and/or other electrolysis system 18. In one embodiment, the fuel cell system 10 is connected and/or attached in series or parallel to an electrolysis system 18, such as one or more electrolyzers 18 in the BOP 16. In another embodiment, the fuel cell system 10 is not connected and/or attached in series or parallel to an electrolysis system 18, such as one or more electrolyzers 18 in the BOP 16.

The present fuel cell system 10 may also be comprised in mobile applications. In an exemplary embodiment, the fuel cell system 10 is in a vehicle and/or a powertrain 100. A vehicle 100 comprising the present fuel cell system 10 may be an automobile, a pass car, a bus, a truck, a train, a locomotive, an aircraft, a light duty vehicle, a medium duty vehicle, or a heavy duty vehicle.

The vehicle and/or a powertrain 100 may be used on roadways, highways, railways, airways, and/or waterways. The vehicle 100 may be used in applications including but not limited to off highway transit, bobtails, and/or mining equipment. For example, an exemplary embodiment of mining equipment vehicle 100 is a mining truck or a mine haul truck.

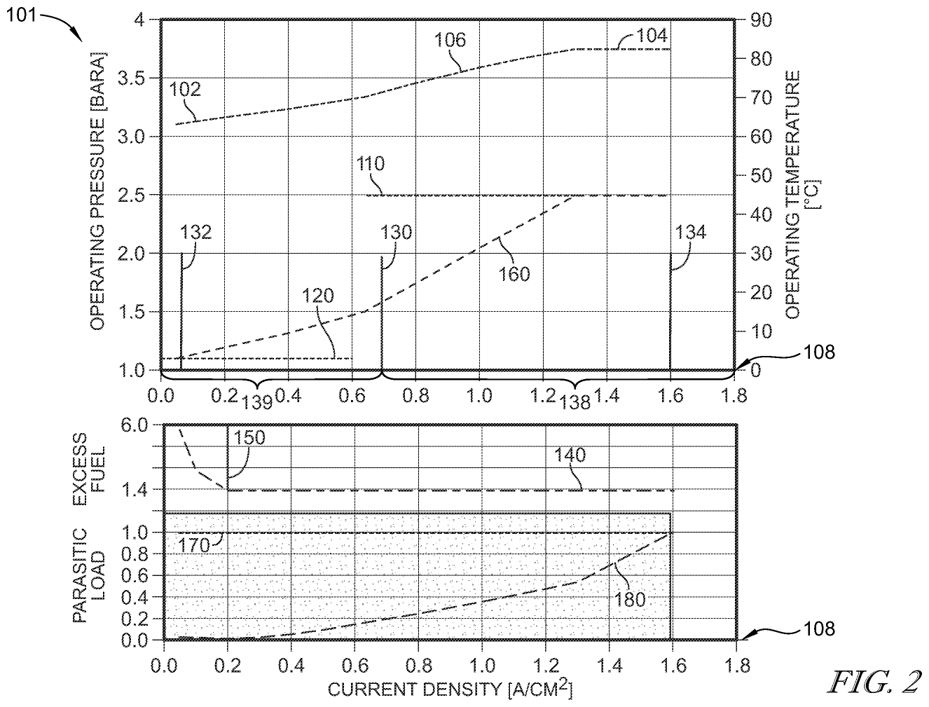

One embodiment of the operating characteristics of fuel cell system 10 comprising a fuel cell 20 or fuel cell stack 12 is illustrated in graph 101 in FIG. 2. Operating pressures and the associated operating temperatures are shown as a function of current density 108. The fuel cell 20 or fuel cell stack 12 may be required to operate within a pressure range known as an anode inlet manifold pressure (P_{AIM}) measured at the anode inlet manifold 404.

A highest anode inlet manifold pressure (P_{AIM_HI}) of a fuel cell 20 or fuel cell stack 12 is denoted by 110. A lowest anode inlet manifold pressure (P_{AIM_HI}) of a fuel cell 20 or fuel cell stack 12 is denoted by 120. The range 160 between the highest anode inlet manifold pressure (P_{AIM_HI}) 110 and the lowest anode inlet manifold pressure (P_{AIM_LO}) 120 indicates a target anode inlet manifold pressure range or operating pressure. A target temperature of the fuel cell system 10 may range from a low fuel supply operating temperature (T_{CV_LO}) 102 to a high fuel supply operating temperature (T_{CV_HI}) 104.

It is critical to operate the fuel cell 20 or fuel cell stack 12 at a pressure that ranges from about or approximately the highest anode inlet manifold pressure (P_{AIM_HI}) 110 to about or approximately the lowest anode inlet manifold pressure (P_{AIM_LO}) 120 when the fuel cell 20 or fuel cell stack 12 is operating above a critical current density (i__{LO_CR}) 130. In some embodiments, the critical current density (i__{LO_CR}) 130 may be at about 0.7 A/cm². In other embodiments, the critical current density (i__{LO_CR}) 130 may be at about 0.6 A/cm². In some further embodiments, the critical current density (i__{LO_CR}) 130 may be higher or lower than 0.7 A/cm², such as ranging from about 0.5 A/cm² to about 0.9 A/cm², including every current density 108 or range of current density 108 comprised therein.

The fuel cell 20 or fuel cell stack 12 may operate at a high current density 138, which may be higher than the critical current density (i__{LO_CR}) 130. The high current density 138 may range from about 1.3 A/cm² to about 2.0 A/cm², or about 1.3 A/cm² to about 1.6 A/cm², or about 1.0 A/cm² to about 1.6 A/cm², including every current density 108 or range of current density 108 comprised therein. In some embodiments, operating the fuel cell 20 or fuel cell stack 12 at such high current density 138 (e.g., at about 1.6 A/cm²) will result in operating the fuel cell 20 or fuel cell stack 12 at pressures and temperatures different from optimal target operating pressures and operating temperatures.

Operating the fuel cell 20 or fuel cell stack 12 at pressures and temperatures different from the optimal target operating pressures and operating temperatures may lower the efficiency of the fuel cell 20 or fuel cell stack 12. Such operation may also result in damage to the fuel cell 20 or fuel cell stack 12 because of MEA 22 degradation (e.g., due to starvation, flooding and/or relative humidity effects). In some embodiments, there may be more flexibility in the fuel cell 20 or fuel cell stack 12 operating pressure and operating temperature when the fuel cell 20 or fuel cell stack 12 is operating below the critical current density (i__{LO_CR}) 130. The present operating system comprising the fuel cell or fuel cell stack can operate at a minimum current density (i_{MIN}) 132 and a maximum current density (i_{MAX}) 134.

In one embodiment, the fuel cell system 10 comprising the fuel cell 20 or fuel cell stack 12 may operate in a functional range that may be different than that indicated by the curve 160 in FIG. 2. The fuel cell system 10 may operate at higher pressures (e.g., the highest anode inlet manifold pressure (P_{AIM_HI}) 110) or at a current density 108 as low as the critical current density (i__{LO_CR}) 130. For example, the fuel cell system 10 may extend steady state operation at about 2.5 bara down to about the critical current density (i__{LO_CR}) 130. Pressure measurements in bara refer to the absolute pressure in bar.

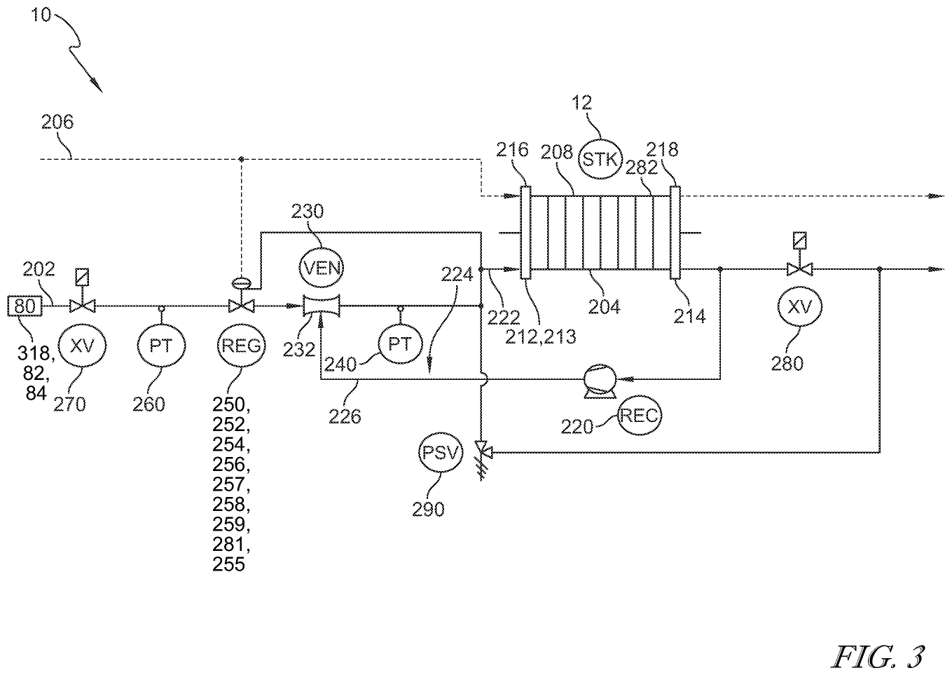

FIG. 3 illustrates one embodiment of a fuel cell system 10 comprising a fuel cell stack 12, a mechanical regulator 250, a recirculation pump or blower 220 in series or in parallel to the fuel cell stack 12, an exhaust valve 280, a shut off valve 270, a pressure transfer valve 290, one or more pressure transducers 240/260, and a venturi or ejector 230. In some embodiments, the fuel cell system 10 may comprise one or more fuel cell stacks 12 or one or more fuel cells 20. In other embodiments, there may also be one or multiple valves, sensors, compressors, regulators, blowers, injectors, ejectors, and/or other devices in series or in parallel with the fuel cell stack 12.

In one embodiment of the fuel cell system 10, an anode inlet stream 222, flows through an anode 204 end of the fuel cell stack 12. Typically, the anode inlet stream 222 may be a mixture of fresh fuel (e.g., H₂) and anode exhaust (e.g., H₂ fuel and/or water). Conversely, oxidant 206 (e.g., air, oxygen, or humidified air) may flow through the cathode 208 end of the fuel cell stack 12.

Excess fuel may be provided at the anode inlet 212 to avoid fuel starvation towards the anode outlet 214. Water content of the anode inlet stream 222 or the relative humidity of the anode inlet stream 222 may impact the performance and health of the fuel cell stack 12. For example, low inlet humidity may lead to a drier membrane electrode assembly (MEA) 22, resulting in reduced performance. Low inlet humidity may also induce stresses that can lead to permanent damage to the membrane electrode assembly (MEA) 22.

High humidity levels may lead to flooding within the fuel cell 20 or fuel cell stack 12, which can induce local starvation and/or other effects that may reduce fuel cell performance and/or damage the membrane electrode assembly (MEA) 22. In some embodiments, there may be an optimal inlet relative humidity range in which fuel cell performance is improved and membrane electrode assembly (MEA) 22 degradation rate is minimized. For example, the fuel cell 20 or fuel cell stack 12 may achieve optimal performance when the relative humidity level of the anode inlet stream 222 is in the range of about 30% to about 35%, including any percentage or range comprised therein.

The source of the excess fuel and water content in a fuel cell 20 may be from a secondary or recirculated flow 226. Composition of the secondary flow 226 in the fuel cell system 10 is dependent on its composition of anode outlet stream 225. In some embodiments, the anode outlet stream 225 may be saturated with water at a given anode gas outlet temperature and pressure. Thus, the variation in the composition of the secondary flow 226 may be taken into account when determining a required secondary flow 226 to meet the excess fuel or relative humidity targets of the anode inlet stream 222.

The required flow rate of the secondary flow 226 can be determined by either the need for excess fuel, or by the need for increased water content, whichever calls for a higher flow of the secondary flow 226. The required flow of the secondary flow 226 can be expressed as the target entrainment ratio (ER). Alternatively, a target effective excess fuel ratio or a minimum required fuel ratio may account for either the need for excess fuel, or for the increased water content of the anode inlet stream 222.

Excess fuel ratio (λ) or the anode stoichiometry ratio is defined as the ratio of anode inlet fuel flow rate to the fuel consumed in the fuel cell 20 or fuel cell stack 12. Excess fuel ratio (λ) may be used to represent the required composition of the secondary flow 226 to meet the required anode inlet stream 222 characteristics. The required anode inlet stream 222 characteristics may be the more stringent of excess fuel ratio or relative humidity requirements of the fuel cell system 10.

Excess fuel ratio (λ) or the anode stoichiometry ratio is defined as the ratio of anode inlet stream 222 flow rate to the fuel consumed in the fuel cell 20 or fuel cell stack 12. Minimum required excess fuel ratio (λ) 140 as a function of current density 108 is shown in FIG. 2. In some embodiments, the fuel cell system 10 requires a fuel amount at or above the minimum required excess fuel ratio (λ) 140. In other embodiments, the fuel cell system 10 may require a target water or humidity level, which may affect the excess fuel ratio (λ) 140. The excess fuel ratio (λ) 140 may be flat across the fuel cell system 10 operating range except at low current densities 108, such as at a current density 108 at or below an excess fuel ratio current density threshold (i__{λ_THV}) 150. Alternatively, or additionally, the excess fuel ratio (λ) 140 may change with a change in current density 108.

In some embodiments, the excess fuel ratio (λ) 140 above the excess fuel ratio current density threshold (i__{λ_THV}) 150 may be in the range from about 1.3 to about 1.9, including any ratio comprised therein. In one preferable embodiment, the excess fuel ratio (λ) 140 above the excess fuel ratio current density threshold (i__{λ_THV}) 150 may be in the range of about 1.4 to about 1.6, including any ratio or range of ratio comprised therein.

In some embodiments, the excess fuel ratio current density threshold (i__{λ_THV}) 150 of the fuel cell system 10 may be at or about 0.2 A/cm². In other embodiments, the excess fuel ratio current density threshold (i__{λ_THV}) 150 may be at a different current density 108. For example, the excess fuel ratio current density threshold (i__{λ_THV}) 150 may be at a current density 108 in the range of about 0.05 A/cm² to about 0.4 A/cm², including any current density 108 or range of current density 108 comprised therein. In one preferable embodiment, the excess fuel ratio current density threshold (i__{λ_THV}) 150 may be about 0.1 A/cm² or about 0.2 A/cm². The excess fuel ratio current density threshold (i__{λ_THV}) 150 may depend on the operating conditions of the fuel cell 20 or fuel cell stack 12.

In one embodiment, if the fuel cell 20 or fuel cell stack 12 is operating below the excess fuel ratio current density threshold (i__{λ_THV}) 150, a minimum volumetric flow rate may be maintained through the anode 204 to flush out any liquid water that might form in the fuel cell 20 or fuel cell stack 12. At low flow rates (e.g., below about 0.2 A/cm² or below about 0.1 A/cm²), there may be flooding in the fuel cell 20 or fuel cell stack 12. If the minimum volumetric flow rate is below the excess fuel ratio current density threshold (i__{λ_THV}) 150, the rate of fuel cell 20 or fuel cell stack 12 degradation may increase and the performance of the fuel cell or fuel cell stack may be adversely affected.

The venturi or ejector 230 may be used in the fuel cell system 10. The venturi or ejector 230 may be sized, such that the fuel cell system 10 may not require the assistance of a recirculation pump 220, such as a blower, at certain current densities 108. Absence of usage of the recirculation pump or blower 220 may result in a decrease in parasitic load, as shown by the curves 170 and 180 of FIG. 2.

The curve 170 shows a fraction of flow that is delivered by the recirculation pump or blower 220 in the absence of a venturi or ejector 230. The curve 180 shows the corresponding parasitic load. The parasitic load may increase with an increase in current density, as shown by the curve 180. This is because recirculation pump or blower 220 may function at a capacity proportional to pressure loss in the fuel cell 20 or fuel cell stack 12 and/or proportional to the required flow rate of the secondary flow 226 in the fuel cell 20 or fuel cell stack 12.

The fuel cell 20 or fuel cell stack 12 may be initially operating at high current density 138, at high operating temperatures and pressures such that the fuel cell load under this initial operating condition is high. The fuel cell load is defined as:

Load=stack power=current×fuel cell or fuel cell stack voltage=current density×fuel cell area×fuel cell or fuel cell stack voltage.

The fuel cell 20 or fuel cell stack 12 may be in a load shedding state when the load demand for power is rapidly reduced or shed requiring the fuel cell 20 or fuel cell stack 12 to reduce the current delivered.

During transient operations in the fuel cell 20 or fuel cell stack 12, the operating pressure in the fuel cell 20 or fuel cell stack 12 may change based on the changes in the fuel cell 20 or fuel cell stack 12 operating temperature. For example, during load shedding, the fuel cell system 10 may have an operating pressure that corresponds to a transient operating pressure (P__{AIM_TRS}) that may be greater than its steady state operating pressure (P__{AIM_SS}). In some embodiments, the transient operating pressure (P__{AIM_TRS}) may equal the highest anode inlet manifold pressure (P_{AIM_HI}) 110 even at low current densities 108. During load acceptance, the rate of increase in current density 108 is limited, and the steady state operating pressure (P__{AIM_SS}) may equal the anode inlet manifold pressure (P_{AIM}).

In one embodiment, the operating pressure of the fuel cell 20 or fuel cell stack 12 may optimize the balance between enabling efficient fuel cell 20 or fuel cell stack 12 operation and the parasitic load required to operate at the chosen operating pressure (e.g., the parasitic load of an air compressor, a blower, and/or a pump). In some embodiments, the operating temperature, operating pressure, and/or excess air ratio 140 may maintain a target relative humidity (RH) for the fuel cell 20 or fuel cell stack 12 operation. The operating temperature, operating pressure, and/or excess air ratio 140 may be determined by targeting a specific value for the relative humidity (RH) at the cathode 208.

The excess air ratio is defined similarly to excess fuel ratio 140, but refers to the cathode 208 side flow (i.e., excess O₂ in the air). The combination of excess air ratio, pressure and temperature are used together to control humidity on the cathode 208 side, which in turn impacts water content on the anode 204 (H₂) side. In one embodiment, temperature, pressure, and excess air ratio that vary with current density may be used to control humidity on the cathode 208 side. In some embodiments, excess air ratio may be about 2.0. In other embodiments, excess air ratio may be in the range of about 1.7 to about 2.1, including any ratio or range of ratio comprised therein. In some other embodiments, excess air ratio may be in the range of about 1.8 to about 1.9, including any ratio or range of ratio comprised therein, under pressurized operation. Excess air ratio may increase to below an air threshold current to keep volumetric flow rate high enough to prevent flooding in the fuel cell 20 or fuel cell stack 12 on the cathode 208 side.

The target relative humidity (RH) may be maintained by using a humidification device in combination with the operating pressure and operating temperature. For example, a humidification device may be used on the cathode 208 side of the fuel cell 20 or fuel cell stack 12. If the target relative humidity (RH) and the target operating pressure of the fuel cell 20 or fuel cell stack 12 are specified, the target temperature for the fuel cell 20 or fuel cell stack 12 operation may be determined.

The mechanical regulator 250 is a control valve 254 that may be used to control the flow of fresh fuel 202 also referred to as primary flow, primary mass flow, primary fuel, or motive flow to the anode 204. Pressure differential between the gas streams (e.g. anode inlet stream 222 and air 206) at the anode 204 and the cathode 208 may provide an input signal 256 to a controller 252 in the mechanical regulator 250.

The controller 252 of the mechanical regulator 250 may determine the flow of the anode inlet stream 222 through an anode inlet 212 at the anode 204. The control valve 254 may be a proportional control valve, or an injector. In other embodiments, the control valve 256 may comprise an inner valve 258, coil 255, or solenoid 257 that controls the opening or closing of the control valve 254. The input signal 256 from the anode 204 and/or cathode 208 of the fuel cell 20 or fuel cell stack 12 may be a physical signal 256 or a virtual (e.g., an electronic) signal 256. The signal may be any type of communicative or computer signal 256 known in the art.

Flow rate of the primary flow 202 or primary flow rate may be controlled to match the fuel consumption in the fuel cell stack 12 based on the operating pressure (e.g., anode pressure). In some embodiments, the pressure in the anode 204 may stabilize when fuel consumption matches the fresh fuel feed at the anode 204 assuming that all other parameters are equal. Since the functioning of the mechanical regulator 250 is based on the pressure differential between the anode 204 and cathode 208, a target pressure differential needs to be maintained when using the mechanical regulator 250. In some embodiments, pressure at the cathode 208 is controlled and/or maintained at a target level via cathode side controls 282.

A mechanically regulated approach, such as by employing actuators 282, may use pressure signals 281 from cathode/air inlet 216 to control mass flow and maintain an appropriate pressure on the cathode 208 side of the fuel cell stack 12. In some embodiments, pressure signals 218 from cathode 208 side are inputs to the mechanical regulator 250. In some embodiments, the anode 204 side mass flow and anode 204 side pressure may be controlled by using the pressure signals 281 from cathode 208 side and measuring one or more anode 204 side conditions.

The pressure signals 281 from cathode 208 side may change the position of an inner valve 258 in the mechanical regulator 250 to control mass flow through the mechanical regulator 250 and maintain the target pressure differential between the anode 204 and the cathode 208. The input signal 256 that acts on the mechanical regulator 250 is effectively a pressure differential that acts on a diaphragm 257 or other parts of the mechanical regulator 250. No other direct measurement of the pressure differential may be undertaken. A single point pressure at the anode 204 may be calculated to be the cathode 208 side pressure plus the pressure differential between the gas streams (e.g., 222) at the anode 204 and the gas streams (e.g., 206) at the cathode 208.

The venturi or ejector 230 may draw the secondary flow 226, also referred to as secondary mass flow, entrainment flow, or recirculation flow, using a flow pressure across an anode gas recirculation (AGR) loop 224. As discussed later, the venturi or ejector 230 may take advantage of the available excess enthalpy from the higher pressure primary flow to draw in the secondary flow 226, working against the pressure losses through the AGR loop 224. The anode gas recirculation loop 224 may include the venturi or ejector 230, the fuel cell stack 12, and a secondary inlet 232, such as one comprised in a suction chamber 620 in the venturi or ejector 230, and/or other piping, valves, channels, manifolds associated with the venturi or ejector 230 and/or fuel cell stack 12. The recirculation pump or blower 220 may increase or decrease the differential pressure across the AGR loop 224.

The fuel cell system 10 may require a target water or humidity level, which may drive the flow of saturated secondary flow 226. The saturated secondary flow 226 may then drive the primary flow 202, such that the target excess fuel ratio (λ) 140 may be dependant on the target water or humidity level.

In one embodiment, the recirculation pump or blower 220 may be used to achieve the excess fuel ratio. The recirculation pump or blower 220 may operate across the entire operating range (current density) of the fuel cell stack 12. The parasitic load of the recirculation pump or blower 220 may be substantial. In one embodiment, a large recirculation pump or blower 220 may be required to provide the power to achieve the target excess fuel ratio (λ) 140. In some embodiments the use of the recirculation pump or blower 220 may be inefficient and expensive. The operating characteristics of a recirculation pump or blower 220 may be distinct from the operating conditions of the venturi or ejector 230.

The pressure lift capability of the recirculation pump or blower 220 (ΔP__{BLWR}) is function of the flow through the recirculation pump or blower 220 (Q), the blower speed (N), and the density of the flow composition (p). The pressure lift of the recirculation pump or blower 220 (ΔP__{BLWR}) may be limited by power draw limits and/or speed limit of the fuel cell system 10. When the recirculation pump or blower 220 is not spinning or is operating under other fuel cell system 10 stall conditions, the recirculation pump or blower 220 may act as a restriction in the AGR loop 224.

$$Δ {P}_{\_ BLWR} = f ( Q , N , ρ ) \qquad ( 1 )$$

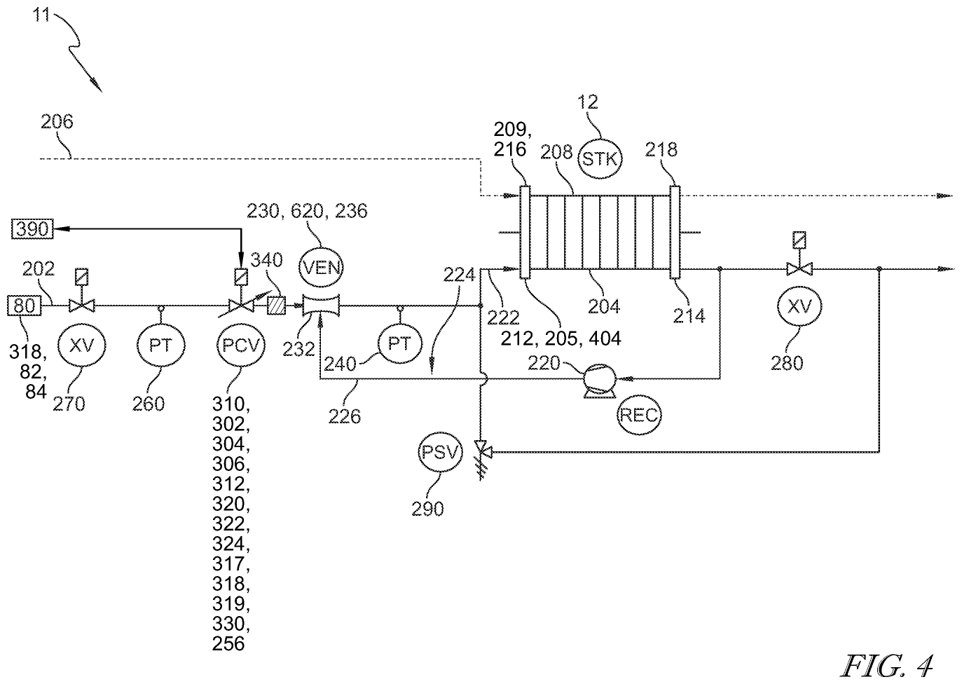

As illustrated in the operating fuel cell system 11 shown in FIG. 4, a proportional control valve 310 may be used instead of a mechanical regulator 250. A proportional control valve 310 is electronically controlled and may provide more flexibility in controlling single point pressure at the anode 204 than the mechanical regulator 250. The proportional control valve 310 may be used to control the primary flow in the fuel cell system 11. In other embodiments, an injector (not shown) may be used instead of a proportional control valve 310.

The proportional control valve 310 may beneficially allow for active management of the differential pressure, may avoid droop issues, and/or provide flexibility in operating the fuel cell stack 12 under different operating conditions. Illustrative operating conditions may include, but are not limited to operating current density, operating pressure, operating temperature, operating relative humidity, fuel supply pressure, fuel supply temperature, required secondary flow, entrainment ratio, parasitic load limitations, power needs, pressure loses in the AGR loop 224, venturi or ejector 230 performance and/or efficiency, recirculation pump or blower 220 performance and/or efficiency, fuel density, purge flow, and choked or unchoked (e.g., not choked) flow conditions.

A turn down ratio of the fuel cell system 10/11 is defined as the ratio of the maximum capacity of the venturi or ejector 230 to the minimum capacity of the venturi or ejector 230. The venturi or ejector 230 may draw the recirculation flow 226 using a primary flow exergy. The turn down ratio characterizes the range over which the venturi or ejector 230 can deliver the required excess fuel ratio (λ) 140 to the fuel cell stack 12.

The fuel cell system 10/11 may be designed to maximize the venturi or ejector 230 turn down ratio. Consequently, maximizing the turn down ratio of the venturi or ejector 230 also works to minimize the size and parasitic load associated with the recirculation pump or blower 220. In some embodiments, the venturi or ejector 230 may be required to operate and/or perform robustly to deliver the required primary flow 202 at the required excess fuel ratio (λ) 140.

In one embodiment, a fuel supply system 80 may supply fuel at a fuel supply pressure (P_{CV}) and a fuel supply temperature (T_{CV}). The primary flow 202 may pass through the control valve 256 and enter the venturi or ejector 230 through a primary nozzle 236 at a primary nozzle inlet pressure (P_{O}) and a primary inlet temperature (T_{O}). The secondary flow 226 may enter the venturi or ejector 230 through a secondary inlet or entrance 232 in a suction chamber 620 at a secondary inlet pressure (P_{S}) and a secondary inlet temperature (T_{S}).

The venturi or ejector 230 may have exergy available in primary flow to induce the anode gas recirculated flow as the secondary flow 226 in the venturi or ejector 230. The stack pressure (ΔP_{STACK}) is the pressure loss through the AGR loop 224. The secondary flow 226 may be lifted against the stack pressure (ΔP_{STACK}).

The pressure lift (ΔP_{LIFT}) is the pressure required to overcome the pressure loses in the AGR loop 224 (ΔP_{STACK}). In some embodiments, the pressure lift (ΔP_{LIFT}) may be dominated by the pressure losses through the fuel cell stack 12 or any other component of the AGR loop 224. In some embodiments, pressure losses may be proportional to volumetric flow rate through one or more manifolds and/or channels in the AGR loop 224. In other embodiments, the volumetric flow 222 at anode inlet 212 may include a mixture of fresh fuel (e.g., H₂) as the primary flow 202 and the recirculation flow 226.

The secondary inlet pressure (P_{S}) may depend on the anode inlet manifold pressure (P_{AIM}) of the fuel cell or fuel cell stack 12 and the pressure loses in the AGR loop 224 (ΔP_{STACK}) or the required pressure lift (ΔP_{LIFT}).

$${P}_{S} = {P}_{AIM} - Δ {P}_{LIFT} \qquad ( 2 )$$

The amount of secondary flow 226 that can be entrained is dictated by the boundary conditions of the fuel cell system 10/11 and the efficiency of the venturi or ejector 230. In some embodiments, the boundary conditions may be the primary nozzle inlet pressure (P_{O}), the secondary inlet pressure (P_{S}), the anode inlet manifold pressure (P_{AIM}) of the fuel cell or fuel cell stack 12, and/or secondary flow 226 composition. In some embodiments, the secondary flow 226 from the anode outlet 214 to the venturi or ejector secondary inlet 232 is an adiabatic process. The primary inlet temperature (T_{O}) and the secondary inlet temperature (T_{S}) of the venturi or ejector 230 may affect secondary flow 226.

As described earlier, above a certain critical current density (i__{LO_CR}) 130, the fuel cell system 10/11 is required to operate in the target anode inlet manifold pressure range indicated by the curve 160 in FIG. 2. The primary inlet pressure (P_{O}) may decrease proportionally with primary fuel demand, until the primary nozzle 236 is no longer choked (unchoked). In other embodiments, if the primary nozzle 236 is unchoked, the rate of decrease of the primary inlet pressure (P_{O}) may be non-linear and/or may be sensitive to downstream pressure such as the secondary inlet pressure (P_{S}). In other embodiments, the primary inlet pressure (P_{O}) may decrease as the primary inlet temperature (T_{O}) decreases.

The primary inlet temperature (T_{O}) may be equal to the fuel supply temperature (T_{CV}). The primary inlet temperature (T_{O}) may affect the primary flow 202. In some embodiments, the fuel cell system 10/11 may have a target mass flow rate. In other embodiments, the secondary inlet temperature (T_{S}) may influence the secondary flow 226 through geometric constraints of the secondary inlet 232 and/or the venturi or ejector 230. In some embodiments, the secondary inlet temperature (T_{S}) may be a geometric constraint. The thermodynamic constraints and/or venturi or ejector 230 efficiency may also influence the secondary flow 226.

The venturi or ejector 230 may be sensitive to the primary nozzle inlet pressure (P_{O}), the backpressure, and the required pressure lift (ΔP_{LIFT}). The backpressure may be an exit pressure at an ejector exit 238 (P_{C}) or may be the anode inlet manifold pressure (P_{AIM}). If there are no pressure losses to the anode inlet manifold from the venturi or ejector 230 outlet, the exit pressure at the ejector exit 238 (P_{C}) may be equal to the anode inlet manifold pressure (P_{AIM}). In some embodiment, the primary nozzle inlet pressure (P_{O}) may be a function of the current density (i) in the fuel cell system 10/11.

$${P}_{O} = f ( i ) \qquad ( 3 )$$

Entrainment ratio (ER), which is a measure of the performance and/or capability of the venturi or ejector 230 and may be sensitive to the primary nozzle inlet pressure (P_{O}), the backpressure (e.g., P_{C}, P_{AIM}) and/or the pressure lift (ΔP_{LIFT}). In one embodiment, as backpressure (e.g., P_{C}, P_{AIM}) increases, the venturi or ejector 230 may change from being double choked (with a stable entrainment ratio), to being in a transitioning condition (with a decreasing entrainment ratio), to having a reverse flow. Reverse flow in the venturi or ejector 230 may be undesirable as reverse flow indicates no fuel recirculation through the AGR loop 224. In some embodiments, the venturi or ejector 230 may need to offset pressure losses through the fuel cell or fuel cell stack 12 (ΔP_{STACK}), while operating against the backpressure (e.g., P_{C}, P_{AIM}).

The reversible entrainment ratio (RER) is defined as the maximum entrainment ratio (ER) of a system for given operating conditions based on thermodynamic limits. In some embodiments, entropy of mixing is not considered because there may not be any elements of the venturi or ejector 230 design that target recovery of chemical potential associated with entropy of mixing.

The actual entrainment ratio (ER) depends on the venturi or ejector 230 design. The venturi or ejector 230 inefficiencies may prevent the reversible entrainment ratio (RER) from being achieved. Geometric constraints may prevent the reversible entrainment ratio (RER) from being achieved. A high reversible entrainment ratio (RER) may be maintained across the entire operating range of the venturi or ejector 230. In some embodiments, at a minimum, the reversible entrainment ratio (RER) may be greater than the required entrainment ratio (target entrainment ratio (ER__{target})) of the fuel cell system 10/11. Target entrainment ratio ER__{target} is the minimum required entrainment ratio (ER). For a given primary inlet pressure (P_{O}), the reversible entrainment ratio (RER) may decrease with an increase in the anode inlet manifold pressure (P_{AM}) and/or increase in the pressure lift (ΔP_{LIFT}).

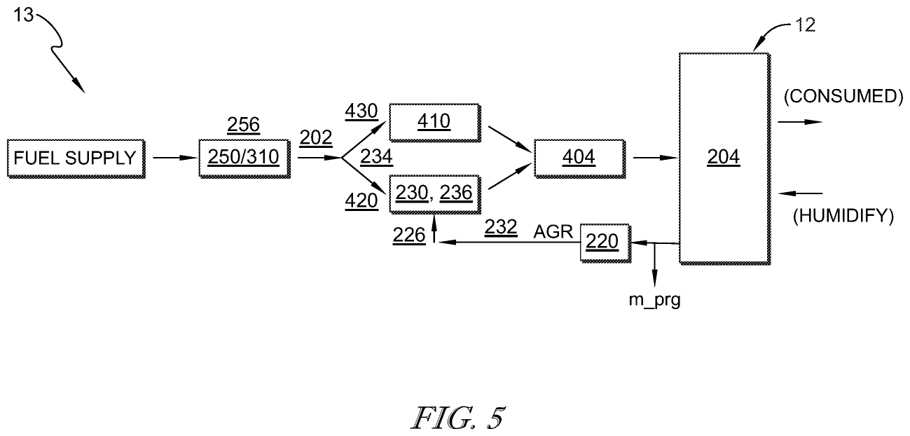

In one embodiment, a fuel cell system 13 may be in a configuration as illustrated in FIG. 5. The venturi or ejector 230, sized to support a fraction of primary flow 202 (e.g., H₂), may be placed in parallel with a by-pass valve or flow restriction 410. At a minimum, the by-pass valve or flow restriction 410 needs open/close functionality, and must be sized to provide remainder of primary flow 202 that does not flow through the venturi or ejector 230. The by-pass valve or flow restriction 410 may be a binary valve with open/close functionality. The by-pass valve or flow restriction 410 may have a variable opening or closing inner valve.

The by-pass valve or flow restriction 410 may be a mechanical regulator, a dome loaded mechanical regulator, an injector, or a proportional control valve. In other embodiments, a configuration comprising a by-pass valve or flow restriction 410 may enable anode gas recirculation (AGR) requirements to be met across the entire operating range (from when the fuel cell system 13 is in idle state to when the fuel cell system 13 is functioning in the state of maximum current density).

In one embodiment, a configuration comprising a by-pass valve or flow restriction 410 (e.g., a proportional control valve) and an adequately sized venturi or ejector 230 may enable anode gas recirculation (AGR) requirements to be met across the entire operating range (from when the fuel cell system 13 is in idle state to when the fuel cell system 13 is functioning in the state of maximum current density) without requiring a recirculation pump or blower 220. Such a configuration is referred to as the EES (elegant ejector system) configuration.

EES size and capability for any AGR system requirements may be determined by computational and/or numerical simulations based on thermodynamic principles, user configurable efficiencies, and/or nominal efficiency values based on literature or computational fluid dynamic (CFD) analysis. In other embodiments, higher fidelity approaches may be needed to define the venturi or ejector 230 design features. In some further embodiments, the range of sizes used in the venturi or ejector 230 may be validated through testing.

A standard venturi or ejector 230 configuration, may have sufficient motive exergy to meet target entrainment ratio (ER__{target}) at the high current densities. Thermodynamics may limit ability to meet target entrainment ratio (ER__{target}) with venturi or ejector 230 at the lower current densities. The venturi or ejector 230 motive pressure may be reduced to reduce the fuel rate to match the fuel cell 20 consumption.

In one embodiment, a EES configuration comprises a smaller venturi or ejector 230 with a by-pass valve or flow restriction 410 such that under high current density operation, the motive exergy available to the venturi or ejector 230 is still sufficient to meet the system target entrainment ratio (ER__{target}) and/or under low current density operation, with a by-pass valve or flow restriction 410 at least partially closed, the motive exergy available is increased such that the reversible entrainment ratio (RER) is substantially increased, enabling the venturi or ejector 230 to meet target entrainment ratio (ER__{target}) requirements.

In one embodiment, in the EES configuration the venturi or ejector 230, the primary nozzle 236 may be downsized by decreasing the primary nozzle diameter. In the EES configuration the venturi or ejector 230, primary nozzle 236 downsizing may be limited because there must be sufficient motive exergy to meet system target entrainment ratio (ER__{system_target}) at the rated current. The reversible entrainment ratio (RER) and ejector efficiency are critical aspects in the EES configuration.

$$\begin{matrix}{ER}_{\_ RES} = f ( {P}_{\_ EMPTY} , {T}_{O \_ SZ} , Δ {P}_{LIFT} ) & ( 4 ) \\ {ER}_{\_ system \_ target} = {ER}_{\_ EES} \times {m}_{\_ H 2 \_ EP} / {m}_{\_ total \_ P} & ( 5 )\end{matrix}$$

where ER__{EES} is the entrainment ratio of the venturi or ejector 230 in the EES configuration, ER__{system_target} is the target entrainment ratio of the system comprising the EES configuration, m__{H2_EP} is the primary mass flow through the venturi or ejector 230 in the EES configuration and m__{total_P} is the total primary mass flow through the fuel cell system 13.

Mixer area ratio (MAR) of the downsized venturi or ejector 230 must be sufficiently large to ensure the system target entrainment ratio (ER__{target}) is met across the operating range. Since the flow m__{H2_EP}, 410 through the venturi or ejector 230 is only a fraction of the full primary flow 202 under higher current conditions, the mixer area ratio (MAR) must be large enough to allow target entrainment ratio of the system (ER__{system_target}) to be met. In one embodiment, the by-pass valve or flow restriction 410 must be sized to enable full primary fuel flow requirement to be met at the rated current density. m__{H2_RP} 430 is the flow through the flow by-pass valve or restriction 410 in the EES configuration. The total primary flow, m__{total_P} 202 is given by:

$${m}_{\_ total \_ P} = {m}_{\_ H 2 \_ EP} + {m}_{\_ H 2 \_ RP} \qquad ( 6 )$$

In one embodiment, the venturi or ejector 230 downsizing in the EES configuration is sufficient to increase the reversible entrainment ratio (RER) at idle current such that target entrainment ratio (ER__{target}) at idle conditions can be met without a blower. Downsizing beyond this point may not be needed. In one embodiment, the by-pass valve or flow restriction 410 may be a mechanical regulator, a dome loaded mechanical regulator, or an injector. In a preferable embodiment, the by-pass valve or flow restriction 410 may be a proportional control valve.

In one embodiment, the by-pass valve or flow restriction 410 is a proportional control valve and the primary nozzle inlet pressure (P_{O}) may be used as an additional variable to maintain the target entrainment ratio (ER__{target}) under different operating ranges. Using the primary nozzle inlet pressure (P_{O}) as a variable may enable a smooth transition between an operation that uses the by-pass valve or flow restriction 410 and an operation that does not use the by-pass valve or flow restriction 410. In other embodiments, the mixer area ratio (MAR) may be designed to maximize the efficiency of the venturi or ejector 230.

In one embodiment, an EES configuration may increase turn down ratio capability significantly. In some embodiments, the increase in the turn down ratio may negate the need for any recirculation pump or blower 220 support under normal operating conditions. In other embodiments, the size of the recirculation pump or blower 220 may be decreased, thus lowering the parasitic load on the fuel cell system 13.

In one embodiment, the fuel cell system 13 may operate at steady state. The stack operating pressure may be a function of the current density. The stack operating temperature may be dependent on stack operating pressure. The purge flow (prg) may keep the anode gas recirculation composition 226 at a constant relative humidity (RH). The pressure loss in the anode recirculation loop 224 may be dependent on mass flow and/or volumetric flow in anode recirculation loop 224.

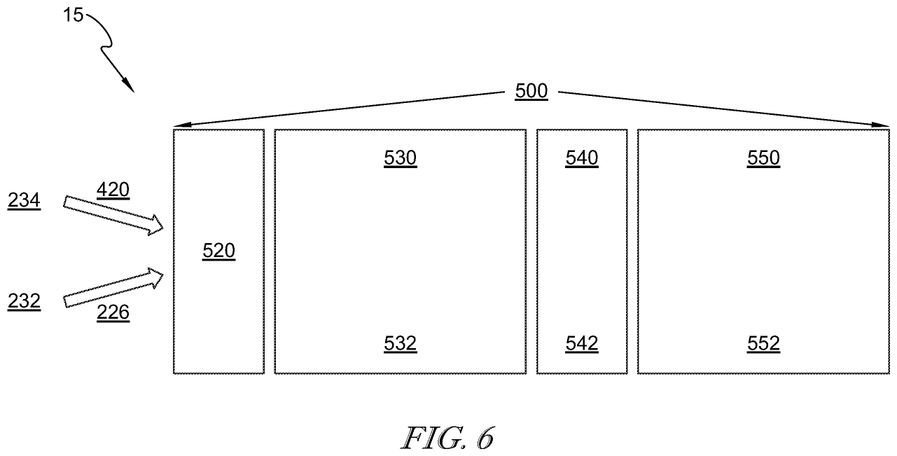

In one illustrative embodiment, as shown in FIGS. 5 and 6, fresh fuel 202 enters a control valve 256 such as a proportional control valve 310 or a mechanical regulator 250 or an injector at a fuel supply temperature (T_{CV}) and fuel supply pressure (P_{CV}). The fresh fuel 202 exits the proportional control valve 310 or the mechanical regulator 250 or the injector and enters the venturi or ejector 230 or flow restriction 410 at a primary nozzle inlet pressure (P_{O}) and primary inlet temperature (T_{O}). A certain amount of the fresh fuel 202 exiting the control valve 256 enters the venturi or ejector 230 (m__{H2_EP}, 420) at the entrance 234.

A certain amount of the fresh fuel 202 exiting the control valve 256 enters the by-pass valve or flow restriction 410 (m__{H2_RP}, 430). The anode gas recirculation composition 226 (m__{RC}) enters the venturi or ejector 230 at the secondary inlet 232 at a secondary inlet pressure (P_{S}) and secondary inlet temperature (T_{S}). The anode gas recirculation composition 226 (m__{RC}) may have water with a mass fraction x__{H2O_RC}. m__{ejector} is the fuel mass flow through the venturi or ejector 230 in the EES configuration and m_ₜₒₜₐₗ is the total fuel mass flow through the fuel cell system 13.

$$\begin{matrix}{m}_{\_ ejector} = {m}_{\_ H 2 \_ EP} + {m}_{\_ RC} & ( 7 ) \\ {m}_{\_ total} = {m}_{\_ H 2 \_ EP} + {m}_{\_ RC} + {m}_{\_ H 2 \_ RP} & ( 8 )\end{matrix}$$

In one embodiment, the anode gas recirculation composition 226 (m__{RC}), the fresh fuel 420 (m__{H2_EP}) that enters the venturi or ejector 230, and the fresh fuel 430 (m__{H2_RP}) that enters the by-pass valve or flow restriction 410 enters an anode inlet manifold 404 of the anode 204 of fuel cell stack 12 at an anode inlet manifold mass (m__{AIM}), an anode inlet manifold pressure (P_{AIM}), an anode inlet manifold temperature (T_{AIM}), and a stack excess fuel ratio or ‘anode stoich’ (λ). A certain mass of fuel is consumed (m__{H2_P}) during the operation of the fuel cell stack 12 and a certain mass of water (m__{H2O_s}), is added to anode recirculation gas composition 226 in the form of humidity.

The fuel cell system 13 may have a purge flow mass (m_prg) to periodically or continuously remove contaminant gases (e.g., N₂) and/or water from the anode gas recirculation composition 226. The amount of primary fuel required (m__{H2_P}) during the operation of the fuel cell stack 12 depends on the amount of fuel consumed (m__{H2_P_FC}) by the fuel cell stack 12 and the amount of mass lost due to purge flow (m_prg).

$${m}_{\_ H 2 \_ P} = {m}_{\_ H 2 \_ P \_ FC} + A \times m\_prg \qquad ( 9 )$$

The purge flow may comprise water and/or other contaminants along with fuel (e.g., H₂) within the anode gas recirculation (AGR) loop 224. A is a factor that accounts for the different densities of various components of the purge flow.

The anode recirculation gas composition 226 (m__{RC}) is circulating with a water content (x__{H2O_RC}) and a temperature (T_{STACK}) before entering the venturi or ejector 230 at the secondary inlet 232. The pressure loss in the anode recirculation loop 224 is the pressure lift (ΔP_{STACK}).

The stack excess fuel ratio or ‘anode stoich’ (λ) is a function of the fresh fuel 420 (m__{H2_EP}) that enters the venturi or ejector 230 and the anode recirculation gas composition 226 (m__{RC}). ‘Anode stoich’ (λ) may be adjusted to account for the purge flow.

$$λ = \frac{( 1 - {x}_{\_ H 2 O \_ RC} ) {m}_{\_ RC} + {m}_{\_ H 2 \_ P \_ FC} + m\_prg}{{m}_{\_ H 2 \_ P \_ FC}} \qquad ( 10 )$$

In one embodiment, entrainment ratio (ER) is a function of the stack excess fuel ratio or ‘anode stoich’ (λ) and the amount of water (x__{H2O_RC}) in the anode recirculation gas composition 226. The system entrainment ratio (ER__{system}) is also defined:

$${ER}_{\_ system} = \frac{λ - 1}{1 - {x}_{\_ H 2 O \_ RC}} \qquad ( 11 )$$

$$When purge flow is zero , {ER}_{\_ system} = \frac{{m}_{\_ RC}}{{m}_{\_ H 2 \_ P}}$$

In one embodiment, the operation of the by-pass valve or flow restriction 410 may be based on user specification of the operation requirements of the fuel cell system 13. A computational and/or numerical simulation may determine the operation of the by-pass valve or flow restriction 410. Alternatively, or additionally, the maximum downsizing of the venturi or ejector 230 (e.g., the EES size) may be estimated based on user specification of the operation requirements fuel cell system 13.

The mixer area ratio (MAR) required to support maximum entrainment ratio (ER) flow may be estimated based on user specification of the operation requirements of the fuel cell system 13. In some embodiments, the operating range of the EES may be estimated (e.g., the turn down ratio) based user specification of the operation requirements of the fuel cell system 13. If the turn down ratio of a baseline venturi or ejector 230 is less than the downsized elegant ejector system i.e. less than 1/EES size, then there may be a need to increase available venturi or ejector 230 motive force as the venturi or ejector 230 approaches EES size (e.g., the area of by-pass valve or flow restriction 410 may be reduced to increase the primary nozzle inlet pressure (P_{O}) and the amount of fresh fuel 420 (m__{H2_EP}) that enters the venturi or ejector 230.

In one embodiment, as shown in FIG. 5, the anode gas recirculation composition 226 (m__{RC}, m__{B}) comprising the entrained flow enters the secondary inlet 232 of the venturi or ejector 230 at the secondary inlet pressure (P_{S}) and secondary inlet temperature (T_{S}). A certain amount of the fresh fuel 202 exiting the fuel supply comprising the motive flow 420 (m__{H2_EP}, m__{A}) enters the entrance 234 of the venturi or ejector 230 at the primary nozzle inlet pressure (P_{O}) and primary inlet temperature (T_{O}). In some embodiments, the venturi or ejector 230 comprises a mixer 500.

As shown in a fuel cell system 15 in FIG. 6, the fresh fuel 420 and the anode gas recirculation composition 226 enter the mixer 500 of the venturi or ejector 230 at the mixer entrance 520 and are mixed in the region 530 form a fuel stream 532. In some embodiments, the fresh fuel 420 and the anode gas recirculation composition 226 are mixed in the region 530 of the venturi or ejector 230 at constant pressure mixing conditions. If the fuel stream 532 is above sonic velocity, the fuel stream 532 can pass through a shock wave, with a corresponding change in velocity, pressure, or temperature.

This shock event generally happens in the venturi or ejector 230. In some embodiments, the fuel stream 532 may enter the shock section 540 of the mixer 500. The fuel stream 532 may go through a shock wave to form a fuel stream 542 in the shock section 540 of the venturi or ejector 230 before passing to the diffuser 550.

The fuel stream 542 may then enter the diffuser 550 and exit the diffuser 550 as fuel stream 552. The fuel stream 552 (m__{C}) exiting the diffuser 550 has a diffuser temperature Tc and diffuser pressure Pc in the diffuser 550. The fuel stream 552 (m__{C}) comprising a mixture of motive flow 420 (m__{H2_EP}, m__{A}) and the secondary flow 226 (m__{RC}, m__{B}) leaves the diffuser 550 of the mixer 500 in venturi or ejector 230 and enters the anode 204 of the fuel cell stack 12 through the anode inlet manifold 404.

The change in entropy of the motive flow (Δs__{M}) and of the entrained flow (Δs__{E}) may be defined as:

$$\begin{matrix}Δ {s}_{\_ M} = {C}_{P \_ A} \times ln ( {T}_{C} / {T}_{0} ) - {R}_{\_ A} ln ( {P}_{C} / {P}_{O} ) & ( 12 ) \\ Δ {s}_{\_ E} = {C}_{P \_ B} \times ln ( {T}_{C} / {T}_{S} ) - {R}_{\_ B} ln ( {P}_{C} / {P}_{S} ) & ( 13 )\end{matrix}$$

C_{P_A} is the specific capacity of the gas composition of the motive flow, C_{P_B} is the specific capacity of the gas composition of the entrained flow, R__{A} is specific gas constant for the gas composition of the motive flow, and R__{B} is gas composition of the entrained flow. Other means to estimate the reversible entropy changes for real gas properties can be similarly derived.

In one embodiment, the process of fuel entering and passing through the venturi or ejector 230 is an adiabatic process. In one embodiment, change in enthalpy of the motive flow 420 (Δh__{M}) is equal to 0 and/or in enthalpy of the entrained flow 226 (Δh__{E}) is equal to 0.

The change in entropy, enthalpy, pressures, temperatures, and/or velocity of the motive flow 420 and the entrained flow 226 as the flow streams (420, 226) pass through the different components (520, 530, 540, 550) of the mixer 500 in the venturi or ejector 230 may be used to calculate the entrained ratio (ER) of the fuel cell system 13, 15. The change in entropy, enthalpy, pressures, temperatures, and/or velocity of the motive flow 420 and the entrained flow 226 may also be used to determine operating limits of the venturi or ejector 230 such as venturi or ejector 230 sizing and/or configuration.

The equations discussed below describing the change in entropy, enthalpy, pressures, temperatures, and/or velocity of the motive flow 420 and the entrained flow 226 as the fuel streams pass through the different components (520, 530, 540, 550) of the mixer 500 in the venturi or ejector 230 may be used in computational and/or numerical models to determine the operating limits of the venturi or ejector 230 and the extent of opening of the by-pass valve or flow restriction 410.

The pressure of the fresh fuel 420 entering the entrance 234 of the venturi or ejector 230 changes from the primary nozzle inlet pressure (P_{O}) to a primary mixer entrance pressure (P_{PE}) and the temperature changes form primary inlet temperature (T_{O}) to a primary entrance temperature (T_{PE}) at the mixer entrance 520. The pressure of anode gas recirculation composition 226 entering the secondary inlet 232 of the venturi or ejector 230 changes from the secondary inlet pressure (P_{S}) to a secondary mixer entrance pressure (P_{SE}) and the temperature changes form the secondary inlet temperature (T_{S}) to a secondary entrance temperature (T_{SE}) at the mixer entrance 520.

A portion of the kinetic energy associated with the fluid mass in the system may be converted to sensible enthalpy (higher temperatures) due to inefficiencies. The change in the entropy (Δs) and the enthalpy (Δh) of motive flow 420 and entrained flow 226 at the mixer entrance 520 may be determined as follows:

$$\begin{matrix}{Δs\_S}_{O} = {C}_{P \_ B} \times ln ( {T}_{SE} / {T}_{S} ) - {R}_{\_ B} ln ( {P}_{SE} / {P}_{S} ) & ( 14 ) \\ {Δh\_S}_{O} = {C}_{P \_ B} \times ( {T}_{SE} - {T}_{S} ) & ( 15 ) \\ {Δs\_P}_{O} = {C}_{P \_ A} \times ln ( {T}_{PE} / {T}_{O} ) - {R}_{\_ A} ln ( {P}_{PE} / {P}_{O} ) & ( 16 ) \\ {Δh\_P}_{O} = {C}_{P \_ A} \times ( {T}_{PE} - {T}_{O} ) & ( 17 )\end{matrix}$$

Under isentropic acceleration, Δs_P_{O}=0

$$\begin{matrix}{T}_{PE} = {T}_{PE} \_rev & ( 18 ) \\ {T}_{S \_ REV} = {( {P}_{S \_ REV} )}^{( ( γ - 1 ) / γ )} & ( 19 ) \\ {Δh\_P}_{O \_ REV} = - {C}_{P} \times {T}_{O} \times ( 1 - {( {P}_{PE} / {P}_{O} )}^{( ( γ - 1 ) / γ )} ) & ( 20 )\end{matrix}$$

γ is C_{P}/C_{V}, C_{P} is the heat capacity at constant pressure and C_{V} is the heat capacity at constant volume.

In one embodiment, T_{PE}_rev is the reversible temperature and P_{PE}_rev is the reversible pressure of the primary flow 420 at the mixer entrance 520 and η_nzl is the efficiency of the primary nozzle 236, 630. Similarly, T_{SE}_rev is the reversible temperature and P_{SE}_rev is the reversible pressure of the secondary flow 226 at the mixer entrance 520, and η_sec is the efficiency of the secondary flow suction chamber 620. The primary flow jet temperature T_{PE} and the secondary flow temperature T_{SE} at the mixer inlet can be represented by:

$$\begin{matrix}{T}_{PE} / {T}_{O} = 1 - η\_nzl ( 1 - {( {P}_{PE} / {P}_{O} )}^{( ( γ - 1 ) / γ )} ) & ( 21 ) \\ {T}_{SE} / {T}_{S} = 1 - η\_sec ( 1 - {T}_{S \_ REV} ) & ( 22 )\end{matrix}$$

The primary nozzle efficiency (η_nzl) for motive flow 420 may be function of nozzle efficiency and jet expansion efficiency, where the jet is the primary flow entering the venturi or ejector 230 through the primary nozzle 236, 630. The primary nozzle efficiency (η_nzl) may be a function of various variable such as primary nozzle design parameters, and the Mach number at the primary nozzle 236, 630 (Ma__{PN}). The efficiency of the secondary flow suction chamber 620 (η_sec) is a function of the design of the secondary flow suction chamber 620, and the Mach number at the secondary inlet (MA SE).

Pr_P_{O} is the ratio of the primary mixer entrance pressure (P_{E}) to the primary nozzle inlet pressure (P_{O}), i.e. P_{E}/P_{O}. Pr_S_{O} is the ratio of the secondary mixer entrance pressure (P_{SE}) to the secondary inlet pressure (P_{S}), i.e. P_{SE}/P_{S}.

In one embodiment, temperature and not pressure may be used to keep track of the velocity of fuel flow in the mixer entrance 520 of the mixer 500. In other embodiments, pressure may be used to keep track of the velocity in the mixer entrance 520 of the mixer 500. In some embodiments, the geometric configuration of the mixer entrance 520 of the mixer 500 may be used to estimate the relative mass flow rates of the motive flow 420 and the entrained flow 226.

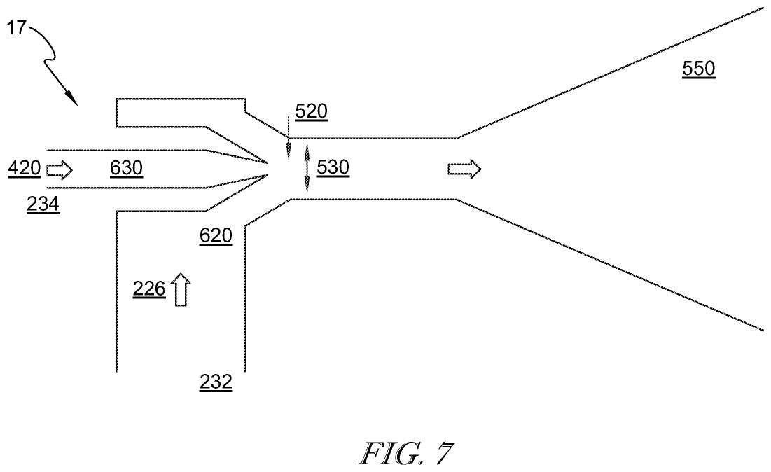

The primary flow entering the mixer region 530 will expand beyond the size of the primary inlet nozzle area is (A__{nzl}) when the Mach number (Ma__{PE}) at the mixer entrance 520 of the mixer 500 with a primary (motive) flow inlet area (A__{PE}) and a secondary (entrained) flow inlet area (A__{SE}) is greater than 1.0. In some embodiments, as shown in a fuel cell system 17 in FIG. 7, the motive flow 420 enters the venturi or ejector 230 at the primary flow entrance 234 and passes through an inlet of the primary nozzle 236, 630, before entering the mixer region 530 at the mixer entrance 520. The entrained flow 226 enters the venturi or ejector 230 through the secondary flow suction chamber 620.

$$\begin{matrix}{A}_{\_ PE} / {A}_{\_ nzl} = \frac{1}{η\_nzl} \times \frac{1}{{Ma\_}_{PE}} \times {\frac{[ 0.5 \times ( γ + 1 ) ]}{{Ma\_}_{PE}}}^{\hat{}} ( ( γ + 1 ) / ( 2 - 2 γ ) ) ] & ( 23 ) \\ {A\_}_{SE} / {A\_}_{nzl} = MAR - {A\_}_{PE} / {A\_}_{nzl} & ( 24 )\end{matrix}$$

The velocity of the motive flow 420 at the mixer entrance 520 (v__{PE}) is:

$${v\_}_{PE} = √ ( 2 \times {C}_{P \_ A} \times ( {T}_{O} / {T}_{PE} ) ) \qquad ( 25 )$$

a__{PE} is the sonic velocity of the motive flow 420 entering the mixer entrance 520.

$$\begin{matrix}{a\_}_{PE} = √ ( {γ\_}_{A} \times {R\_}_{A} \times {T}_{PE} ) & ( 26 ) \\ {γ\_}_{A} is {C}_{P \_ A} / {C}_{V \_ A} , {R\_}_{A} is {R}_{univ} / {MW}_{A} , & ( 27 ) \\ {v\_}_{PE} = {Ma\_}_{PE} \times {a\_}_{PE} & ( 28 )\end{matrix}$$

Ma__{PE} is the Mach number of the motive flow 420 entering the mixer entrance 520.

$$\begin{matrix}{Ma\_}_{PE} = {v\_}_{PE} / {a\_}_{PE} & ( 29 ) \\ {ρ}_{PE} = {P}_{E} / {R\_}_{A} / {T}_{PE} & ( 30 )\end{matrix}$$

ρ_{PE} the density of the composition of the motive flow when the motive flow enters the mixer entrance 520.

m__{A} is the mass of the motive flow entering the mixer entrance 520, m__{B} is the mass of the entrained flow entering the entering the mixer entrance 520, ρ_{SE} the density of the composition of the entrained flow entering the mixer entrance 520, a__{SE} is the sonic velocity where the entrained flow 226 entering the mixer entrance 520, Ma__{SE} is the Mach number of the secondary flow 226 entering the mixer entrance 520.

$$\begin{matrix}{m\_}_{A} = {A\_}_{PE} \times {Ma\_}_{PE} \times {a\_}_{PE} \times {ρ}_{PE} & ( 31 ) \\ {m\_}_{A} / {A\_}_{nzl} = {A\_}_{PE} / {A\_}_{nzl} \times {Ma\_}_{PE} \times {a\_}_{PE} \times {ρ}_{PE} & ( 32 ) \\ {m\_}_{B} / {A\_}_{nzl} = ( MAR - {A\_}_{PE} / {A\_}_{nzl} ) \times {Ma\_}_{SE} \times {a\_}_{SE} \times {ρ}_{SE} & ( 33 ) \\ {m\_}_{A} / {A\_}_{nzl} = {A\_}_{PE} / {A\_}_{nzl} \times {Ma\_}_{PE} \times {a\_}_{PE} \times {ρ}_{PE} & ( 34 ) \\ {m\_}_{B} / {A\_}_{nzl} = ( MAR - {A\_}_{PE} / {A\_}_{nzl} ) \times {Ma\_}_{SE} \times {a\_}_{SE} \times {ρ}_{SE} & ( 35 )\end{matrix}$$

The motive flow 420 mixes with the entrained flow 226 in the mixer region 530 after passing through the mixer entrance 520 at constant pressure to form a fuel stream 532. Momentum balance is achieved between the motive flow 420 and entrainment flow 226 that mix to form the fuel stream 532. Thermal balance is achieved between the motive flow 420 and entrainment flow 226 that mix to form the fuel stream 532.

There may be inefficiencies due to loss of momentum when the motive flow 420 mixes with the entrained flow 226 in the mixer region 530. Losses in the mixer region 530 may be assumed to be proportional to the momentum (e.g., m__{A}v_{A}, m__{B}v_{B}), where η_MX is the mixer efficiency, VA is the velocity of the motive flow entering the venturi or ejector 230, and v_{B} is the velocity of the entrained flow entering the venturi or ejector 230.

$$\begin{matrix}( {m\_}_{A} + {m\_}_{B} ) \times {v}_{M} = √ ( η\_MX ) \times ( {\_}_{A} {v}_{PE} + {m\_}_{B} {v}_{SE} ) & ( 36 ) \\ ( {m\_}_{A} + {m\_}_{B} ) \times {v}_{M} = {m\_}_{A} {V}_{PM} + {m\_}_{B} {v}_{SM} & ( 37 ) \\ {v}_{PM} = √ ( η\_MX ) \times {v}_{PE} & ( 38 ) \\ {v}_{SM} = √ ( η\_MS ) \times {v}_{SE} & ( 39 )\end{matrix}$$

v_{PE} is velocity of the motive flow 420 at the mixer entrance 520, VSE is velocity of the entrained flow 226 at the mixer entrance 520, v_{M} is the velocity of the fuel stream 532 in the mixer region 530, v_{PM} is velocity of the motive flow 420 and T_{PM} is the temperature of the motive flow 420 in the mixer region 530, v_{SM} is velocity of the entrained flow 226 and T_{SM} is the temperature of the entrained flow 226 in the mixer region 530.

Each fuel stream entering the mixer region 530 may be treated independently. In some embodiments, there may be an effective temperature change of the fuel stream 532 in the mixer region 530 due momentum loses in the mixer region 530.

$$\begin{matrix}{v}_{PM}^{2} = η\_MX \times {v}_{PE}^{2} & ( 40 ) \\ {v}_{PE}^{2} = 2 \times {C}_{P} \times ( {T}_{O} - {T}_{PE} ) & ( 41 ) \\ {v}_{PM}^{2} = 2 \times {C}_{P} \times ( {T}_{O} - {T}_{PM} ) & ( 42 ) \\ {v}_{PE}^{2} - {v}_{PM}^{2} = ( 1 - η\_MX ) \times {v}_{PE}^{2} = 2 \times {C}_{P \_ A} \times ( {T}_{PE} - {T}_{O} ) & ( 43 ) \\ 2 \times {C}_{P \_ A} \times ( {T}_{PM} - {T}_{PE} ) = ( 1 - η\_MX ) \times {v}_{PE}^{2} & ( 44 ) \\ {T}_{PM} = {T}_{PE} + 0.5 \times ( 1 - η\_MX ) \times {v}_{PE}^{2} / {C}_{P\_ A} & ( 45 ) \\ Similarly , {T}_{SM} = {T}_{SE} + 0.5 \times ( 1 - η\_MS ) \times {v}_{SE}^{2} / {C}_{A \_ B} & ( 46 )\end{matrix}$$

The change in enthalpy of the motive flow Δh__{PM}) in the mixer region 530 and the change in enthalpy of the entrained flow (Δh__{SM}) in the mixer region 530 is calculated as:

$$\begin{matrix}{Δh\_}_{PM} = {C}_{P \_ A} \times ( {T}_{PE} - {T}_{PM} ) & ( 47 ) \\ {Δh\_}_{SM} = {C}_{P \_ B} \times ( {T}_{SE} - {T}_{SM} ) & ( 48 )\end{matrix}$$

In one embodiment, the mixing of the motive flow 430 and the entrained flow 226 in the mixer region 530 is a constant pressure process and the change in entropy of the motive flow (Δs__{PM}) and of the entrained flow (Δs__{SM}) in the mixer region 530 is calculated as:

$$\begin{matrix}{Δs\_}_{PM} = {C}_{P \_ A} ln ( {T}_{PM} / {T}_{PE} ) & ( 49 ) \\ {Δs\_}_{SM} = {C}_{P \_ B} ln ( {T}_{SM} / {T}_{SE} ) & ( 50 )\end{matrix}$$

The motive flow 420 and the entrainment flow 226 may mix adiabatically in the mixer region 530 while maintaining a momentum balance. Such mixing may depend on the entrainment ratio (ER). A simulation of such mixing requires an iterative solution so that the first and second law of thermodynamics are not violated. In one embodiment, entrainment ratio (ER) may be used to calculate the properties of the fuel stream 532.

$$\begin{matrix}ER = {m\_}_{B} / {m\_}_{A} & ( 51 ) \\ {m\_}_{C} / {m\_}_{A} = 1 + ER & ( 52 ) \\ {C}_{P \_ C} = ( {C}_{P \_ A} + ER \times {C}_{P \_ B} ) / ( 1 + ER ) & ( 53 ) \\ {MW\_}_{C} = {y\_}_{H 2 \_ C} \times {MW\_}_{H 2} + {y\_}_{H 2 O \_ C} \times {MW\_}_{H 2 O} & ( 54 ) \\ {R\_}_{C} = {R}^{*} / {MW\_}_{C} & ( 54 ) \\ {γ\_}_{C} = {C}_{P \_ C} / ( {C}_{P \_ C} - {R\_}_{C} ) & ( 55 )\end{matrix}$$

m__{C} is the combined mass of the motive flow 420 and the entrainment flow 226, C_{P_C} is combined heat capacity the motive flow 420 and the entrainment flow 226, R* is the universal gas constant, R__{C} is the combined gas constant of the motive flow 420 and the entrainment flow 226, y__{H2_C} is the moles of hydrogen in the combined motive flow 420 and the entrainment flow 226, y__{H2O_C} is the moles of water in the motive flow 420 and the entrainment flow 226, MW__{H2} is the molecular weight of hydrogen, and MW__{H2O} is the molecular weight of water. γ__{C} is C_{P_C}/C_{V_C}, where C_{P_C} is the combined heat capacity of the motive flow 420 and the entrainment flow 226 at constant pressure, and C_{V_C} is the combined heat capacity of the motive flow 420 and the entrainment flow 226 at constant volume.

In one embodiment, thermal balance in the mixer region 530 may be used to calculate temperature of the fuel stream 532.

$$\begin{matrix}{m\_}_{C} \times {C}_{P \_ C} \times {T}_{M} = {m\_}_{A} \times {C}_{P \_ A} \times {T}_{PM} + {m\_}_{B} \times {C}_{P \_ B} \times {T}_{SM} & ( 56 ) \\ {C}_{P \_ C} ( 1 + ER ) \times {T}_{M} = {C}_{P \_ A} \times {T}_{PM} + ER \times {C}_{P \_ B} \times {T}_{SM} & ( 57 )\end{matrix}$$

Similarly, the total temperature is calculated as:

$${C}_{P \_ C} ( 1 + ER ) \times {T}_{C} = {C}_{P \_ A} \times {T}_{O} + ER \times {C}_{P \_ B} \times {T}_{SM} \qquad ( 58 )$$

T_{M} is the temperature of the fuel stream 532 in the mixer region 530 after the motive flow 420 and the entrained flow 226 have been mixed. T_{C} is the temperature of the fuel stream that leaves the mixer 500. In some embodiments, T_{C} is the temperature of the fuel stream 552 that leaves the venturi or ejector 230 through the diffuser 550.

In one embodiment, after the temperatures of the gas stream fuel stream 532 in the mixer region 530 is determined, the velocity (v_{M}) of the fuel stream 532 in the mixer region 530 after the motive flow 420 and the entrained flow 226 have been mixed can be calculated:

$${v}_{M}^{2} = 2 \times {C}_{P \_ C} ( {T}_{C} - {T}_{M} ) \qquad ( 59 )$$

The Mach number (Ma__{M}) in the mixer region 530 may be determined as follows:

$$\begin{matrix}{a\_}_{M} = √ ( {γ\_}_{C} \times {R\_}_{C} \times {T}_{M} ) & ( 60 ) \\ {Ma\_}_{M} = {v\_}_{M} / {a\_}_{M} & ( 61\end{matrix}$$

a__{M} is the sonic velocity in the mixer region 530.

Shock waves in the shock section 540 of the mixer 500 may increase the entropy of the fuel stream 542. In some embodiments, shock waves in the shock section 540 of the mixer 500 may increase the entropy of the fuel stream 542 if the Mach number (Ma__{M}) in the mixer region 530 is greater than 1.0. In one embodiment, the Mach number (Ma__{SH}) in the shock area changes across the shock section 540 of the mixer 500.

$${Ma\_}_{SH}^{2} = [ 1 + 0.5 \times ( {γ\_}_{C} - 1 ) \times {Ma\_}_{M}^{2} ] / [ {γ\_}_{C} \times {Ma\_}_{M}^{2} - 0.5 \times ( {γ\_}_{C} - 1 ) ] \qquad ( 61 )$$

The change in enthalpy (Δh_{SH}) in the shock section 540 of the mixer 500 is:

$$Δ {h}_{SH} = {C}_{P \_ C} \times ( {T}_{SH} - {T}_{M} ) \qquad ( 62 )$$

T_{SH} is the temperature of the fuel stream 542.

The change in entropy (Δs_{SH}) in the shock section 540 of the mixer 500 is:

$$Δ {s}_{SH} = {C}_{P \_ C} \times ln ( {T}_{SH} / {T}_{M} ) - {R\_}_{C} \times ln ( {P}_{SH} / {P}_{M} ) \qquad ( 63 )$$

P_{SH} is the pressure of the fuel stream 542.

$$\begin{matrix}{P}_{SH} / {P}_{M} = 1 + 2 \times ( {γ\_}_{C} ( {γ\_}_{C} + 1 ) ) \times ( {Ma\_}_{M}^{2} - 1 ) & ( 64 ) \\ {v}_{SH} / {v}_{M} = [ 1 + 0.5 \times ( {γ\_}_{C} - 1 ) \times {Ma\_}_{M}^{2} ] / [ 0.5 \times ( {γ\_}_{C} - 1 ) \times {Ma\_}_{M}^{2} ] & ( 65 ) \\ {ρ}_{SH} / {ρ}_{M} = {v}_{M} / {v}_{SH} & ( 66 ) \\ {T}_{SH} / {T}_{M} = {P}_{SH} / {P}_{M} \times {ρ}_{M} / {ρ}_{SH} & ( 67 )\end{matrix}$$

ρ_{SH} is the density of the fuel stream 542 and v_{SH} is the velocity of the fuel stream 542.

In one embodiment, the fuel stream 552 may be decelerated through the diffuser 550 to recover pressure. The fuel stream 552 may undergo expansion to the temperature determined from enthalpy balance and pressure recovery in the fuel stream 552 may be limited. Efficiency of the diffuser, η_diff is a function of the mixer length, the diffuser design, expansion ratio, expansion angle, and/or Ma__{SH}.

The fuel stream 542 may transition to the fuel stream 552 via an intermediary state. The fuel stream 542 may undergo an isentropic deceleration to an intermediary state (DF′) and an isenthalpic expansion from the intermediary state (DF′) to an exit state (C) (e.g., fuel stream 552). The change in enthalpy (Δh_{DF′}) when the fuel stream 542 changes to the intermediary state DF′ in the section in the section 550 of the venturi or ejector 230 is:

$$\begin{matrix}Δ {h}_{{DF}^{′}} = η\_diff \times {C}_{p} \times ( {T}_{C} - {T}_{SH} ) & ( 68 ) \\ {T}_{{DF}^{′}} = η\_diff ( {T}_{C} - {T}_{SH} ) + {T}_{SH} & ( 69 )\end{matrix}$$

The change in entropy (Δs_{DF′}) when fuel stream 542 changes to state DF′ in the section 550 of the venturi or ejector 230 is:

$$\begin{matrix}Δ {s}_{{DF}^{′}} = 0 = {C}_{P} ln ( {T}_{{DF}^{′}} - {T}_{SH} ) - R ( {P}_{{DF}^{′}} / {P}_{SH} ) & ( 70 ) \\ {P}_{{DF}^{′}} / {P}_{SH} = {( {T}_{{DF}^{′}} - {T}_{SH} )}^{( γ / ( γ - 1 ) )} & ( 71 ) \\ {P}_{{DF}^{′}} = {P}_{C} & ( 72 )\end{matrix}$$

P_{DF′} is the pressure and T_{DF′} is the temperature of the fuel stream 542 in the intermediary state (DF′), P_{C} is the pressure T_{C} is the temperature of the fuel stream 552 exiting the diffuser 550 of the venturi or ejector 230.

The change in entropy, enthalpy, pressures, temperatures, and/or velocity of the motive flow 420 and the entrained flow 226 may be modeled as a single irreversible entropy generating step to calculate the entrainment ratio (ER) of the fuel cell system 13, 15, 17 and determine the operating limits of the venturi or ejector 230 and/or the extent of opening of the by-pass valve or flow restriction 410. The equations discussed below describing the change in entropy, enthalpy, pressures, temperatures, and/or velocity of the motive flow 420 and the entrained flow 226 may be modeled as a single irreversible entropy generating step to be used in computational and/or numerical models.

The entrainment ratio may be based on thermodynamic analysis with a single loss term. In other embodiments, boundary conditions may be based on the operating conditions of the fuel cell system 13, 15, 17 such as pressure lift (ΔP_{LIFT}), the target entrainment ratio (ER__{target}), empty pressure (P_{EMPTY}), anode bias pressure (P_{BIAS}) i.e. difference in the pressure at the anode 204 and cathode 208, and/or primary inlet nozzle pressure (P_{O}).

The pressure lift (ΔP_{LIFT}) requirement may be based on the pressure loss expected under conditions where the target entrainment ratio (ER__{target}) is achieved. In some embodiments, the fuel cell system 13, 15, 17 may be adiabatic. In some embodiments, the venturi or ejector 230 outlet temperature (Tc) may be calculated based on enthalpy balance:

$$( 1 + ER ) \times {C}_{P \_ C} \times {T}_{C} = {C}_{P \_ A} \times {T}_{O} + ( 1 + ER ) \times {C}_{P \_ B} \times {T}_{S} \qquad ( 73 )$$

The primary inlet temperature (T_{O}) may not be equal to the secondary inlet temperature (T_{S}). A single non-isentropic process may be modelled within the venturi or ejector 230 and/or all losses in the venturi or ejector 230 may be represented by internal ejector efficiency (η_ejc). The losses may comprise nozzle inefficiency, expansion of the primary flow entering the mixer region 530, any mixing losses, loses due to a shock wave, and losses in the diffuser 550.

The level of loss may be proportional to the kinetic energy in the mixer region 530:

$$\begin{matrix}η\_ejc = \frac{{v}_{PM}^{2}}{{v}_{PE}^{2}} = \frac{{v}_{SM}^{2}}{{v}_{SE}^{2}} & ( 74 ) \\ {P}_{SE} = {P}_{PE} = {P}_{S} / {pr\_}_{CR} & ( 75 ) \\ {T}_{PE} = {T}_{O} \times {( {P}_{PE} / {P}_{O} )}^{( γ - 1 ) / γ} & ( 76 ) \\ {T}_{SE} = {T}_{S} \times {( {P}_{SE} / {P}_{s} )}^{( γ - 1 ) / γ} & ( 77 ) \\ {T}_{PM} = {T}_{O} - η\_ejc ( {T}_{O} - {T}_{PE} ) & ( 78 ) \\ {T}_{SM} = {T}_{S} - η\_ejc ( {T}_{S} - {T}_{SE} ) & ( 79 )\end{matrix}$$

pr__{CR} is the critical pressure ratio. The critical pressure ratio is ˜1.9 for H₂, or ˜1.88 for water saturated recirculation flow at typical fuel cell operating temperatures and pressures.

PE/SE and PM/SM may be used to define individual states of motive and entrained flows at the mixer entrance 520 and at the mixer region 530. In some embodiments, the flow streams 420 and 226 at the mixer entrance 520 are assumed to be choked in the mixer 500. In one embodiment, a single irreversible entropy generating step may provide the same loss in entropy regardless of actual entrainment ratio (ER).

In one embodiment, there are no losses. In some embodiments, there is a decrease in velocity due to internal ejector losses that may result in an increase in the temperature that may not be recovered in the deceleration process in the diffuser 550. In other embodiments, the first and second laws of thermodynamics are combined, enabling the calculation of entrainment ratio (ER) through the exergy relationship as shown below. Assuming constant heat capacity (C_{P}), ideal gas composition, and not considering the entropy of mixing:

$$- ( {Δs\_}_{M} - {Δs\_}_{GEN \_ M} ) = ER \times ( {Δs\_}_{E} \times {Δs\_}_{GEN \_ E} ) \qquad ( 80 )$$

In one embodiment, reversible components of the motive (Δs__{M}) and entrained (Δs__{E}) entropy is:

$$\begin{matrix}{Δs\_}_{M} = {C}_{P \_ C} ln ( {T}_{C} / {T}_{O} ) - {R\_}_{A} ln ( {P}_{C} / {P}_{O} ) & ( 81 ) \\ {Δs\_}_{E} = {C}_{P \_ B} ln ( {T}_{C} / {T}_{S} ) - {R\_}_{B} ln ( {P}_{C} / {P}_{S} ) & ( 82 )\end{matrix}$$

In one embodiment, irreversible components of the motive (Δs__{GEN_M}) and entrained (Δs__{GEN_E}) entropy is:

$$\begin{matrix}{Δs\_}_{GEN \_ M} = {C}_{P \_ A} ln ( {T}_{PM} / {T}_{PE} ) & ( 83 ) \\ {Δs\_}_{GEN \_ E} = {C}_{P \_ B} ln ( {T}_{SM} / {T}_{SE} ) & ( 84 ) \\ ER = - ( {Δ\_}_{M} - {Δs\_}_{GEN \_ M} ) / ( {Δ\_}_{E} - {Δs\_}_{GEN \_ E} ) & ( 85 )\end{matrix}$$

The size of the venturi or ejector 230 in an EES configuration may be estimated based on the ratio of estimated entrainment ratio (ER) to the target entrainment ratio (ER__{target}) i.e. ER/ER__{target} at the rated current conditions of the system. The estimated entrainment ratio (ER) of a system may be determined based on the equations discussed above. The use of a proportional control valve as a by-pass valve or flow restriction 410 may determine the size of the venturi or ejector 230 in the system. The size of the venturi or ejector 230 may be estimated based on based on the actual entrainment ratio (ER), the target entrainment ratio (ER__{target}), the thermodynamic limits of the system (e.g., reversible entrainment ratio (RER)) and/or other operational conditions or characteristics of the system.

Operational conditions or characteristics of the system may comprise a mixer area ratio (MAR) of the venturi or ejector 230, component efficiencies, required pressure lift (ΔP_{LIFT}), operating conditions (empty pressure (P_{EMPTY}), anode bias pressure (P_{BIAS}), and/or primary inlet nozzle pressure (P_{O})), and/or the operating point of the system (e.g., current density). Geometrically constrained mass flows (motive flow 420, entrained flow 226) may be determined under double choked conditions. The backpressure to achieve double choked condition may be determined. The primary pressure required to deliver target mass flow may be estimated. Reversible and irreversible cases may be considered.

Losses in each component of the venturi or ejector 230 (entrances 234, 232, nozzle 236, 630, suction chamber 620, mixer entrance 520, mixer region 530, diffuser 550, mixer region 530, shock section 540) may be used to estimate irreversible losses. Adiabatic process, ideal gases conditions, constant specific heats, and/or compressible fluids may be assumed. In some embodiments, component efficiencies may be applied under double choked conditions.

The required pressure lift (ΔP_{LIFT}) in the system may be based on the flow rates when target entrainment ratio (ER__{target}) is met. The target entrainment ratio (ER__{target}) may be based on the minimum excess fuel ratio of the system (λ_MIN). In some embodiments, the minimum excess fuel ratio of the system (λ_MIN) may depend on the operational conditions of the system. In some embodiments, entrainment ratios (ER) are calculated using the pressure lift (ΔP_{LIFT}) associated with the target entrainment ratio (ER__{target}).

If the estimated entrainment ratio (ER) is greater than the target entrainment ratio (ER__{target}), the fuel cell system 13 would experience a higher pressure lift (ΔP_{LIFT}) requirement and thus, such estimated entrainment ratios (ER) may not be realized and the actual entrainment ratio (ER) may be lower than the estimated value. Although the actual values of the entrainment ratio (ER) may not be realized, the entrainment ratio (ER) realized may still be greater than or equal to the target entrainment ratio (ER__{target}). The entrainment ratio (ER) capability of the system may be used to estimate downsizing of the venturi or ejector 230 to a size such that the target entrainment ratio (ER__{target}) is met under all operating conditions of the system.

The required pressure lift (ΔP_{LIFT}) capability of a venturi or ejector 230 may be predicted based on component efficiencies, and/or operating conditions (empty pressure (P_{EMPTY}), anode bias pressure (P_{BIAS}), and/or primary inlet nozzle pressure (P_{O})). In one embodiment, component efficiencies may comprise primary nozzle efficiency (η_nzl), suction efficiency at the secondary inlet (η_sec), mixer efficiency (η_MX), diffuser efficiency (η_diff), motive flow efficiency (η_M), and/or entrained flow efficiency (η_E).

$$\begin{matrix}η\_M = η\_nzl \times η\_MX \times η\_diff & ( 86 ) \\ η\_e = η\_sec \times η\_MX \times η\_diff & ( 87 )\end{matrix}$$

For a certain mixer area ratio (MAR), certain ejector component efficiencies, and operating point (current density), the operating range of the venturi or ejector 230 may be determined. In some embodiments, the maximum entrainment ratio for reversible and loss cases may be determined. (e.g., if ER is constrained by geometry, then maximum entrainment ratio for reversible and loss cases may be the same). In other embodiments, the maximum pressure lift (ΔP_{LIFT}) available at full entrainment ratio (ER) may be determined. If exit pressure at the venturi or ejector 230 (Pc) is less than a critical outlet pressure (P__{critical}) below which the venturi or ejector 230 is double choked, geometry limited flow through the venturi or ejector 230 is known as critical entrainment ratio (ER__{critical}). Any further reduction in the exit pressure at the venturi or ejector 230 (P_{C}) will not increase the entrainment ratio (ER) above the critical entrainment ratio (ER__{critical}).

For a given mixer area ratio (MAR), ejector component efficiencies, and operating point (current density), the conditions for meeting the pressure lift (ΔP_{LIFT}) requirements may be determined. In some embodiments, for the given ejector exit pressure (P_{C}) at any given operating condition, the entrainment ratio (ER) and reversible entrainment ratio (RER) may be determined. In other embodiments, the ejector efficiency (relative to RER) may be determined. In one embodiment, the ejector efficiency may be optimized under conditions where target entrainment ratio (ER__{target})/reversible entrainment ratio (RER) is most constrained to extend EES operation across the entire operating range of the system.

The EES configuration may provide a wider operating range and allowing for recirculation pump or blower 220 downsizing. In some embodiments, the downsizing of the venturi or ejector 230 in an EES configuration is based on ER/ER__{target} ratio at a rated current. The ER/ER__{target} ratio is different from the turndown ratio. In other embodiments, the turndown ratio may be considered when the ejector performance falls off.

In one embodiment, the adjusted entrainment ratio (ER__{adjusted}) is the same as the system entrainment ratio (ER__{system}). The entrainment ratio (ER) is the entrainment ratio of the venturi or ejector 230. The adjusted critical entrainment ratio (ER__{critical_adjusted}) is the maximum entrainment ratio capability of the fuel cell system 13.

The critical entrainment ratio (ER__{critical}) is the maximum entrainment ratio capability of the venturi or ejector 230. In some embodiments, the critical entrainment ratio (ER__{critical}) accounts for thermodynamic limits and the geometric limits of the venturi or ejector 230 and the adjusted critical entrainment ratio (ER__{critical_adjusted}) accounts for thermodynamic limits and the geometric limits of the fuel cell system 13.

The fuel cell system 13 comprising a by-pass valve or flow restriction 410 may comprise more than one venturi or ejector 230 in parallel of series configuration. The primary nozzle 236, 630 or any other component of the more than one venturi or ejector 230 may be sized differently to account for the entrainment ratio requirements of the fuel cell system 13.

The fuel cell system 13 comprising a by-pass valve or flow restriction 410 may meet the target entrainment ratio (ER__{target}) at both high rated current density and low current density. In some embodiments, the fuel cell system 13 may be driven by an excess exergy ratio.

If the primary inlet nozzle area is (A__{nzl}) and the a secondary (entrained) flow inlet area (A__{SE}), a mixer area ratio (MAR) is:

$$MAR = ( {A\_}_{nzl} + {A\_}_{SE} ) / {A\_}_{nzl} \qquad ( 88 )$$

If the primary nozzle 236, 630 of the venturi or ejector 230 is downsized i.e., the primary inlet nozzle area is (A__{nzl}) is downsized and the secondary (entrained) flow inlet area (A__{SE}) is kept constant, the mixer area ratio (MAR) may increase to account for the decrease in the primary inlet nozzle area is (A__{nzl}).

For example, if the fully sized mixer area ratio (MAR) may be equal to 5, the primary inlet nozzle area (A__{nzl}) may be about 1 unit, the secondary (entrained) flow inlet area (A__{SE}) may be about 4 units. If the venturi or ejector 230 is downsized by a factor of 4, the nominal increase in the mixer area ratio (MAR) may be by a factor of about 3.4 to about 17. In some other embodiments, the increase in the mixer area ratio (MAR) may be a trade-off between the highest operating current density and the lowest operating current density for the fuel cell system 10, 11, 13 comprising the venturi or ejector 230.

In some other embodiments, the mixer area ratio (MAR) may be increased to be in a range from about 15 (i.e. increased by a factor of about 3) to about 19 (i.e. increased by a factor of about 3.8), including any ratio comprised therein. In other embodiments, the mixer area ratio (MAR) may be increased to be in a range from about 12 (i.e. increased by a factor of about 2.4) to about 17 (i.e. increased by a factor of about 3.4), including any ratio comprised therein. In some other embodiments, the mixer area ratio (MAR) may be increased to be in a range from about 12 (i.e. increased by a factor of about 2.4) to about 19 (i.e. increased by a factor of about 3.8), including any ratio comprised therein.

For example, if the fully sized mixer area ratio (MAR) may be equal to 5, the primary inlet nozzle area (A__{nzl}) may be about 1 unit, the secondary (entrained) flow inlet area (A__{SE}) may be about 4 units. If the venturi or ejector 230 is downsized by a factor of 2, the nominal increase in the mixer area ratio (MAR) may be by a factor of about 1.8 to about 9. In some other embodiments, the increase in the mixer area ratio (MAR) may be a trade-off between the highest operating current density and the lowest operating current density for fuel cell system 10, 11, 13 comprising the venturi or ejector 230.

In some other embodiments, the mixer area ratio (MAR) may be increased to be in a range from about 7 (i.e. increased by a factor of about 1.4) to about 10 (i.e. increased by a factor of about 2), including any ratio comprised therein. In other embodiments, the mixer area ratio (MAR) may be increased to be in a range from about 8 (i.e. increased by a factor of about 1.6) to about 14 (i.e. increased by a factor of about 2.8), including any ratio comprised therein. In some other embodiments, the mixer area ratio (MAR) may be increased to be in a range from about 7 (i.e. increased by a factor of about 1.4) to about 14 (i.e. increased by a factor of about 2.8), including any ratio or range of ratios comprised therein.

The fuel cell system 10, 11, 13 may comprise an internal ejector efficiency of about 30% to about 40%, about 40% to about 50%, about 50% to about 60%, including any percentage or percentage range comprised therein. In some embodiments, the mixer area ratio (MAR) may be large such that geometric restriction may not apply to fuel cell system 13. The mixer area ratio (MAR) may be in the range of about 5 to about 7, of about 7 to about 10, of about 10 to about 15, or of about 15 to about 25, including any number or number range comprised therein.

In other embodiments, the amount of motive flow 420 that may pass through the by-pass valve or flow restriction 410 may comprise about 0% to about 10%, about 10% to about 20%, about 20% to about 30%, about 30% to about 40%, about 40% to about 50%, about 50% to about 60%, about 60% to about 70%, about 70% to about 80%, about 80% to about 90%, about 90% to about 100%, including any percentage or percentage range comprised therein. In a preferred embodiment, the by-pass valve or flow restriction 410 may be adjusted to allow a percentage of motive flow 420 that will allow the fuel cell system 13 achieve its target entrainment ratio (ER__{target}).

In one embodiment, a method of using a fuel cell 20 or fuel cell stack 12 comprising a venturi or ejector 230 includes sizing and operating the venturi or ejector 230 to increase the operating range and control the recirculation flow rate of the entrainment flow 226. In some embodiments, the method includes flowing primary fuel 420 through the venturi or ejector 230 and flowing primary fuel 430 through a by-pass control valve 410 situated in a parallel configuration to the venturi or ejector 230.

In other embodiments, the method includes determining the size of the venturi or ejector 230 by changing the size of the primary nozzle 236, 630, and/or adjusting the mixer area ratio (MAR) of the venturi or ejector 230 to account for the primary fuel 430 flowing through the by-pass control valve 410, and contributing to the entrainment flow 226. In some embodiments, determining the amount of primary fuel 430 flowing through the by-pass valve 410 and the primary fuel 420 flowing through the venturi or ejector 230 depends on the rated current density, required entrainment ratio (ER) and/or the operational conditions of the fuel cell system 13 comprising the a fuel cell or fuel cell stack 12.

### EXAMPLES

### Example 1

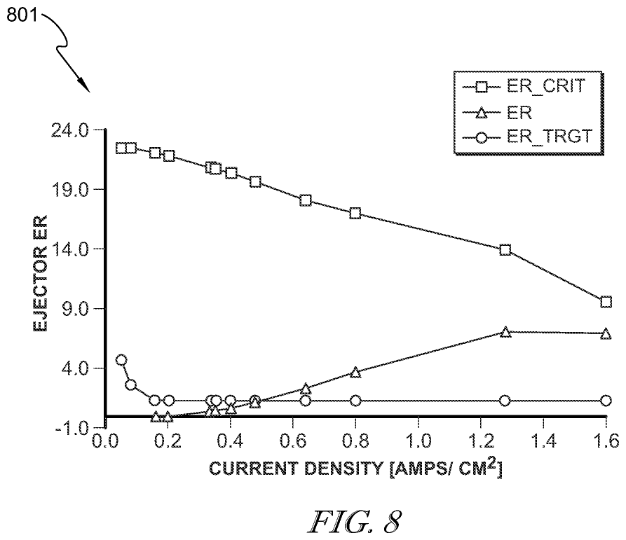

In one embodiment, the fuel cell system 10, 11, 13, 15, or 17 may comprise a venturi or ejector 230 in isolation, empty pressure (P_{EMPTY}) of about 12 bara, primary inlet nozzle pressure (P_{O}) of about 5.7 bara, pressure lift (ΔP_{LIFT}) of about 0.15 bara, a purge flow rate (prg) of 10%, a sizing temperature (T_{O_SZ}) of 85° C. Graph 801 in FIG. 8 shows the entrainment ratio (ER), the critical entrainment ratio (ER__{critical}), the target entrainment ratio (ER__{target}), and the reversible entrainment ratio of the system as function of current density when the internal ejector efficiency is about 60%. As illustrated, extending a single ejector operation below a current density of about 0.5 Amps/cm² is not practical for the given operating conditions as the entrainment ratio (ER) dips below the target entrainment ratio (ER__{target}).

### Example 2

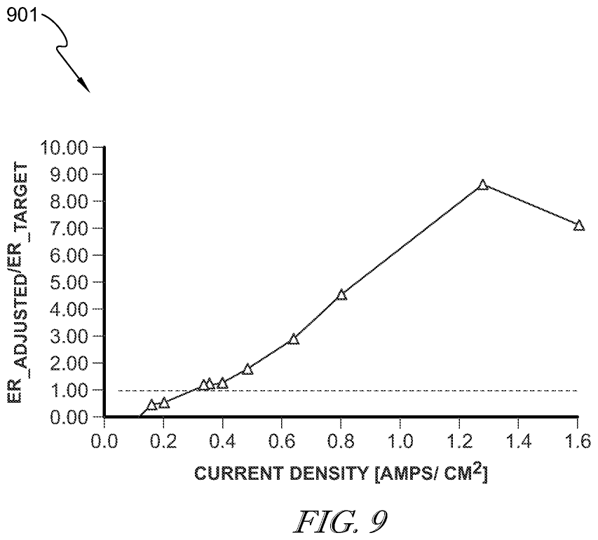

In one embodiment, as shown in graph 901 in FIG. 9, even with a 100% efficient ejector, the 10, 11, 13, 15, or 17 may not be able to extend operation below about −0.4 Amps/cm² for a given set of operating conditions as the venturi or ejector 230 may be thermodynamically limited. The ratio of the adjusted entrainment ratio (ER__{adjusted}) to the target entrainment ratio (ER__{target}) should be at or greater than 1 for the system to operate.

### Example 3

In one embodiment, if the rated current density is about 1.6 Amps/cm², the ejector component efficiencies (η_nzl, η_sec, η_MX, and η_diff range from about 85% to about 90%), and mixer area ratio (MAR) is about 100, there may not be any geometric constraints of entrainment ratio (ER) and reversible entrainment ratio (RER). ER/RER=45% if η_M=η_E=˜65%. In some embodiments, efficiency of the venturi or ejector 230 degrades as the mixer area ratio (MAR) increases, so the entitlement entrainment ratio or the entrainment ratio capability may not be known.

### Example 4

In one embodiment, if the mixer area ratio (MAR) is from about 5 to about 15, there may be geometric constraints on the entrainment ratio (ER) and reversible entrainment ratio (RER). In some embodiments, the efficiency of the venturi or ejector 230 is a function of the mixer area ratio (MAR). In some embodiments, the mixer region 530 efficiency may decrease by about 1% to about 2% per unit increase in the mixer area ratio (MAR). In other embodiments, the ER/RER ratio may decrease due to geometric constraints. For example, decreasing mixer area ratio (MAR) from 100 to 10 may change the ER/RER ratio at the rated current from about 45% to about 15%. In some embodiments, geometric constraints may provide more motive flow capability as the current density is dropped.

### Example 5

In one embodiment, the operating range of the venturi or ejector 230 is sensitive to empty fuel supply pressure (empty pressure (P_{EMPTY})) and the fuel supply temperature (T_{CV}) range. In some embodiments, higher empty pressure (P_{EMPTY}) and stable fuel supply temperature provides wider, more robust operating range. For example, an empty pressure (P_{EMPTY}) of 12 bara, a fuel supply temperature (T_{CV}) of about 85° C., and purge flow rate (prg) of about 10% may provide a robust operating range of the venturi or ejector 230.

### Example 6

In one embodiment, pressure lift (ΔP_{LIFT}) and component ejector efficiency (η_nzl, η_sec, η_MX, and η_diff) may affect the operating range of the venturi or ejector 230. The operating range of the venturi or ejector 230 may depend on these variables. For example, a pressure lift (ΔP_{LIFT}) of about 15 kPa at the target ER and a mixer area ratio (MAR) of about 10 with overall η_M and η_E of about 65% may provide a robust operating range of the venturi or ejector 230. In some embodiments, the current density (i) may be about 1.6 A/cm². The ER/RER ratio may be about 15%. The turn down ratio may be about 4 and EES primary nozzle 236, 630 size may be about 0.4 A/cm².

### Example 7

In one embodiment, the full size venturi or ejector 230 will not be able to meet ER__{target} at a current density that is below about 10% of the rated current density. For example, at a current density that is about 7% of the rated current density, the reversible entrainment ratio (RER) may be too low (i.e., even with 100% efficient venturi or ejector 230, the venturi or ejector 230 cannot deliver the ER). However, at about 10% of the rated current, RER is about 7. In some embodiments, ER/RER ratio may be about 20%. The venturi or ejector 230 may be able to meet the target entrainment ratio (ER__{target}).

### Example 8

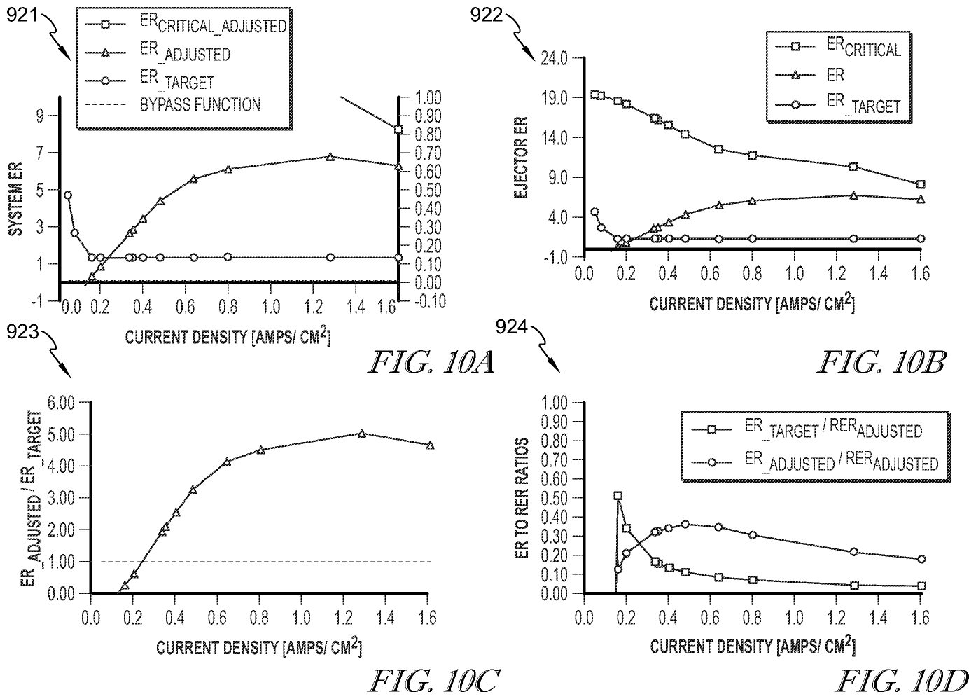

In one embodiment, as shown in graphs 921, 922, 923, 924 in FIGS. 10A-10D, the fuel cell system 10, 11, 13, 15, or 17 may have a maximum pressure lift (ΔP_{LIFT}) of about 0.15 bara and comprise a venturi or ejector 230 in an EES configuration with an EES size of 1.0, a large mixer area ratio (MAR) value such that geometric restriction may not apply to system (e.g., MAR is about 13), and an ejector efficiency of about 60%. A binary by-pass valve or flow restriction 410 may be used. The adjusted entrainment ratio (ER__{adjusted}) may be above the target entrainment ratio (ER__{target}) for some current densities above about 0.21 Amps/cm². Additional motive exergy may be available beyond system requirement.

### Example 9

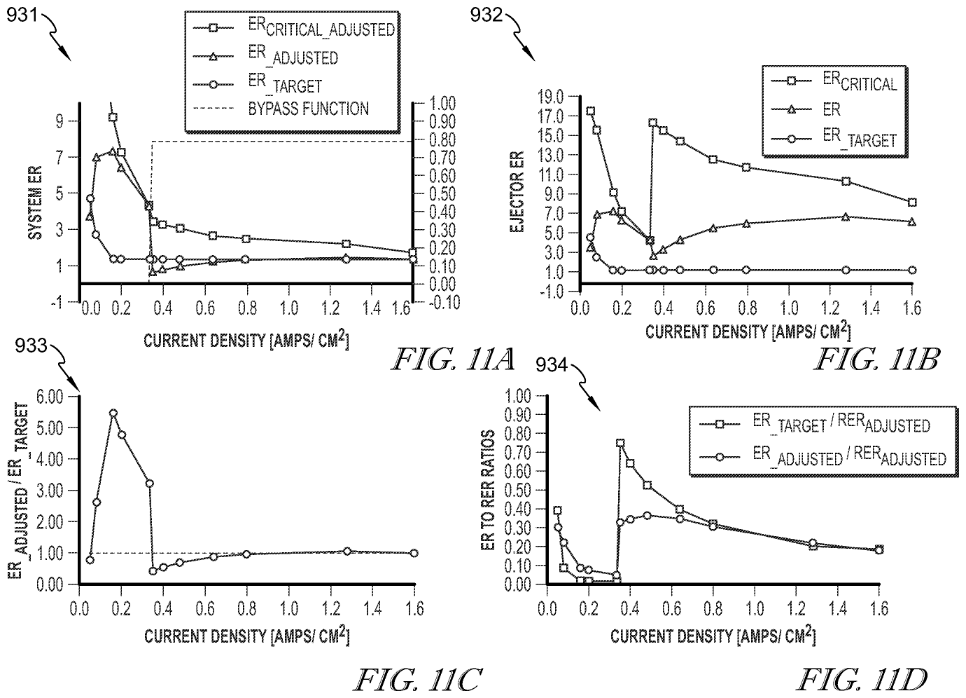

In one embodiment, as shown in graphs 931, 932, 933, 934 in FIGS. 11A-11D, the fuel cell system 10, 11, 13, 15, or 17 may have a maximum pressure lift (ΔP_{LIFT}) of about 0.15 bara, and comprise a venturi or ejector 230 in an EES configuration with an EES size of 0.21, a large mixer area ratio (MAR) value such that geometric restriction may not apply to system (e.g., MAR is about 13), and an ejector efficiency of about 60%. A binary by-pass valve or flow restriction 410 may be used. The primary nozzle 236, 630 is sized for the given fraction of the full flow at the rated current of about 0.34 Amps/cm². The adjusted entrainment ratio (ER__{adjusted}) may be below the target entrainment ratio (ER__{target}) at some current densities such as above about 0.35 Amps/cm² or below about 0.65 Amps/cm². Additional motive exergy may be available beyond system requirement at some current densities such as below about 0.35 Amps/cm².

### Example 10

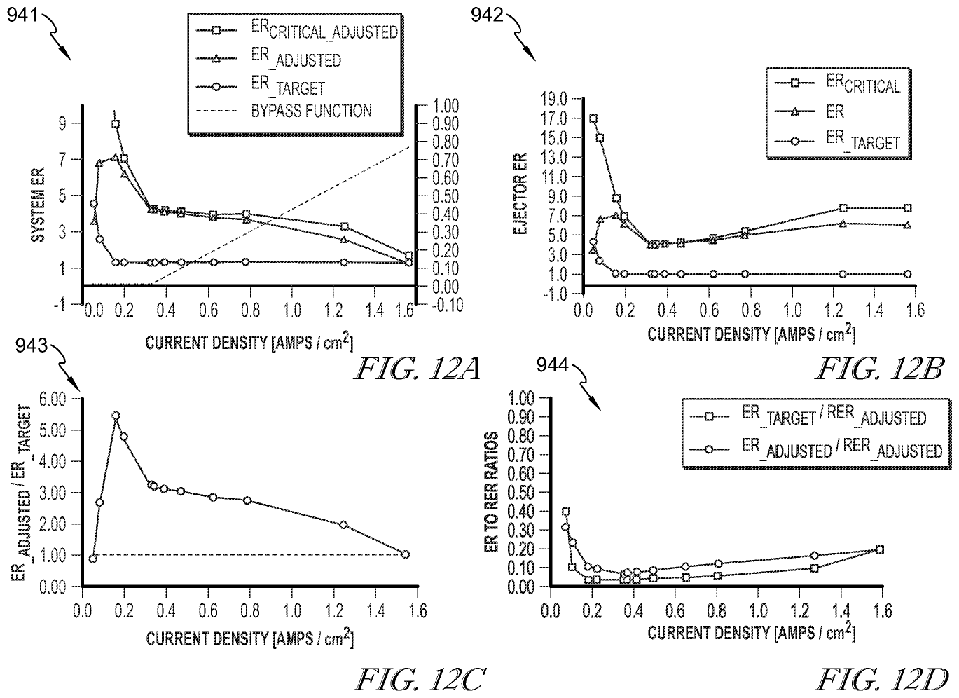

In one embodiment, as shown in graphs 941, 942, 943, 944 in FIGS. 12A-12D, the fuel cell system 10, 11, 13, 15, or 17 may have a maximum pressure lift (ΔP_{LIFT}) of about 015 bara, and comprise a venturi or ejector 230 in an EES configuration with an EES size of 0.21, a large mixer area ratio (MAR) value such that geometric restriction may not apply to system (e.g., MAR is about 13), and an ejector efficiency of about 60%. The primary nozzle 236, 630 is sized for the given fraction of the full flow at the rated current of about 0.34 Amps/cm². The by-pass valve or flow restriction 410 may be set such that flow through the venturi or ejector 230 is maximized i.e., the primary nozzle inlet pressure (P_{O}) is maximized. There may be no flow fraction through the by-pass valve or flow restriction 410. In this configuration, the adjusted entrainment ratio (ER__{adjusted}) may be greater than the target entrainment ratio (ER__{target}) across entire operating range, extending below EES_size (0.21). The adjusted entrainment ratio (ER__{adjusted}) may track the critical adjusted entrainment ratio (ER__{critical_adjusted}). The system may not have any additional motive exergy.

### Example 11

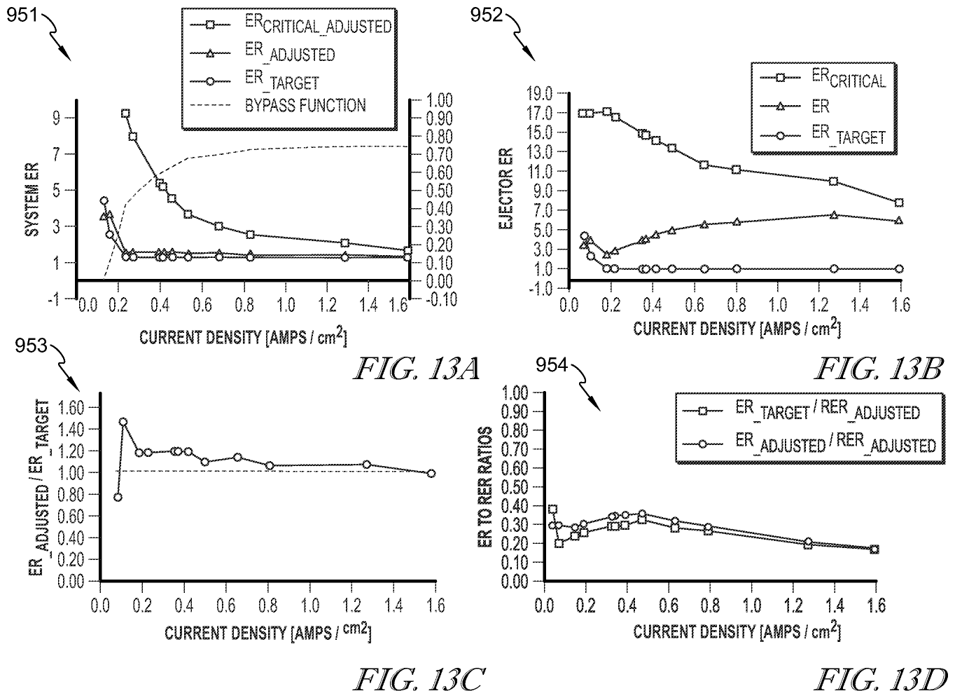

In one embodiment, as shown in graphs 951, 952, 953, 954 in FIGS. 13A-13D, the fuel cell system 10, 11, 13, 15, or 17 may have a maximum pressure lift (ΔP_{LIFT}) of about 0.15 bara, and comprise a venturi or ejector 230 in an EES configuration with an EES size of 0.21, a large mixer area ratio (MAR) value such that geometric restriction may not apply to system (e.g., MAR is about 13), and an ejector efficiency of about 60%. The primary nozzle 236, 630 is sized for the given fraction of the full flow at the rated current of about 0.34 Amps/cm². The by-pass valve or flow restriction 410 may comprise a proportional valve. The by-pass valve flow fraction of the by-pass valve or flow restriction 410 may be adjusted to control adjusted entrainment ratio (ER__{adjusted}) across the operating conditions. The by-pass valve may be fully open at a 100% load conditions and fully closed at idle conditions. In this configuration, the adjusted entrainment ratio (ER__{adjusted}) may track the target entrainment ratio (ER__{target}) across entire operating range.

### Example 12

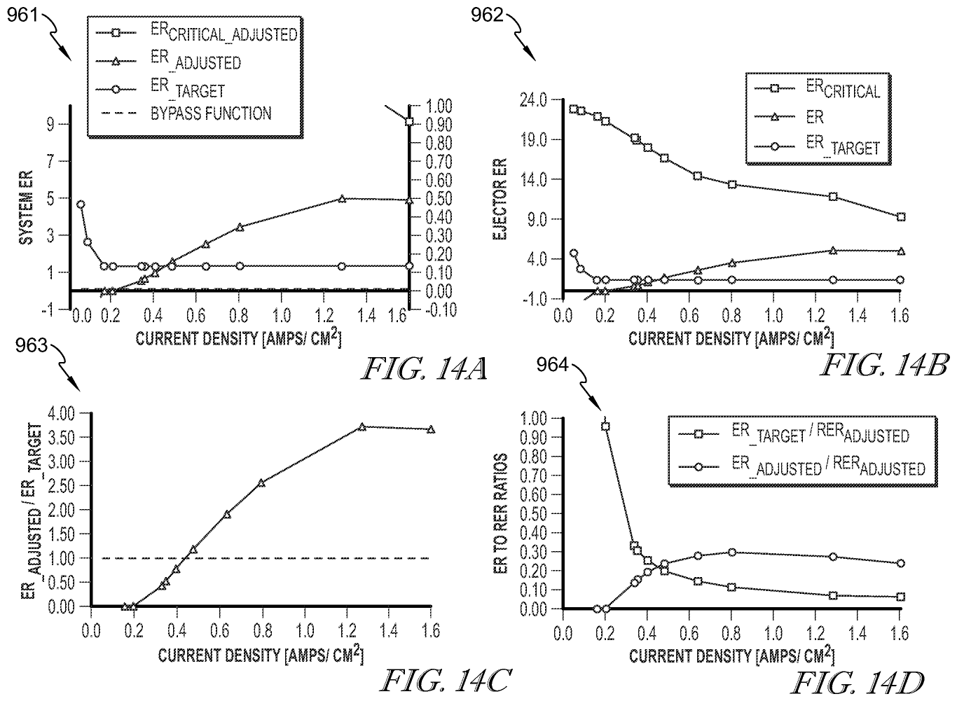

In one embodiment, as shown in graphs 961, 962, 963, 964 in FIGS. 14A-14D, the fuel cell system 10, 11, 13, 15, or 17 may have a maximum pressure lift (ΔP_{LIFT}) of about 0.25 bara, and comprise a venturi or ejector 230 in an EES configuration with an EES size of 1.0, a large mixer area ratio (MAR) value such that geometric restriction may not apply to system (e.g., MAR is about 15), and an ejector efficiency of about 50%. A binary by-pass valve or flow restriction 410 may be used. The adjusted entrainment ratio (ER__{adjusted}) may be above the target entrainment ratio (ER__{target}) for some current densities above about 0.4 Amps/cm². Additional motive exergy may be available beyond system requirement.

### Example 13

In one embodiment, as shown in graphs 971, 972, 973, 974 in FIGS. 15A-15D, the fuel cell system 10, 11, 13, 15, or 17 may have a maximum pressure lift (ΔP_{LIFT}) of about 0.25 bara, and comprise a venturi or ejector 230 in an EES configuration with an EES size of 0.27, a large mixer area ratio (MAR) value such that geometric restriction may not apply to system (e.g., MAR is about 15), and an ejector efficiency of about 50%. A binary by-pass valve or flow restriction 410 may be used. The primary nozzle 236, 630 is sized for the given fraction of the full flow at the rated current of about 0.43 Amps/cm². The adjusted entrainment ratio (ER__{adjusted}) may be below the target entrainment ratio (ER__{target}) at some current densities such as above about 0.48 Amps/cm² or below about 1.3 Amps/cm². Additional motive exergy may be available beyond system requirement at some current densities such as below about 0.42 Amps/cm².

### Example 14

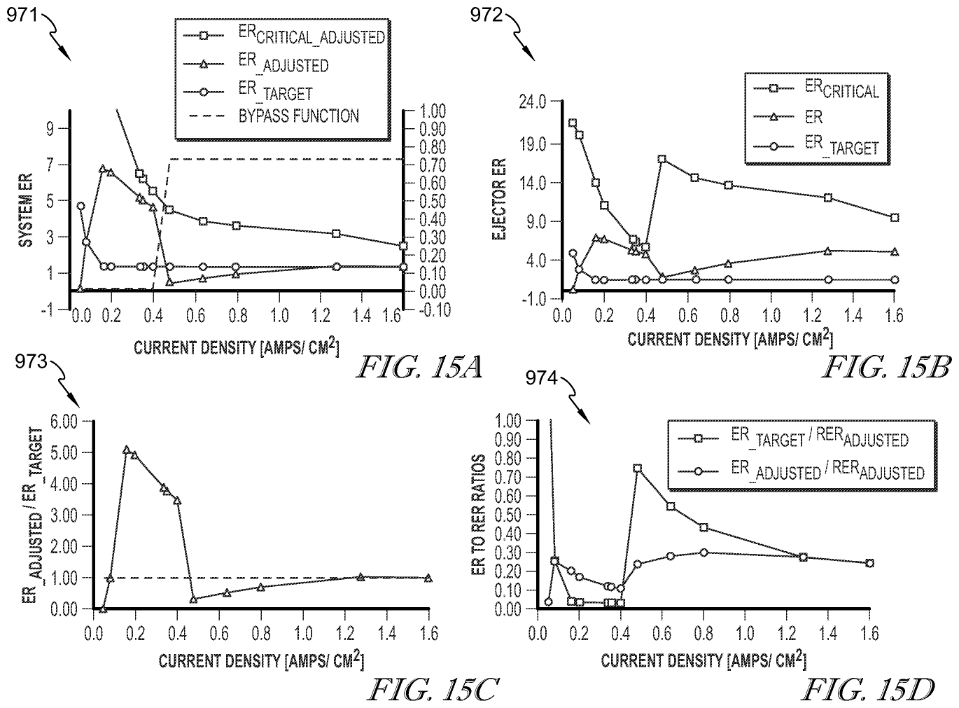

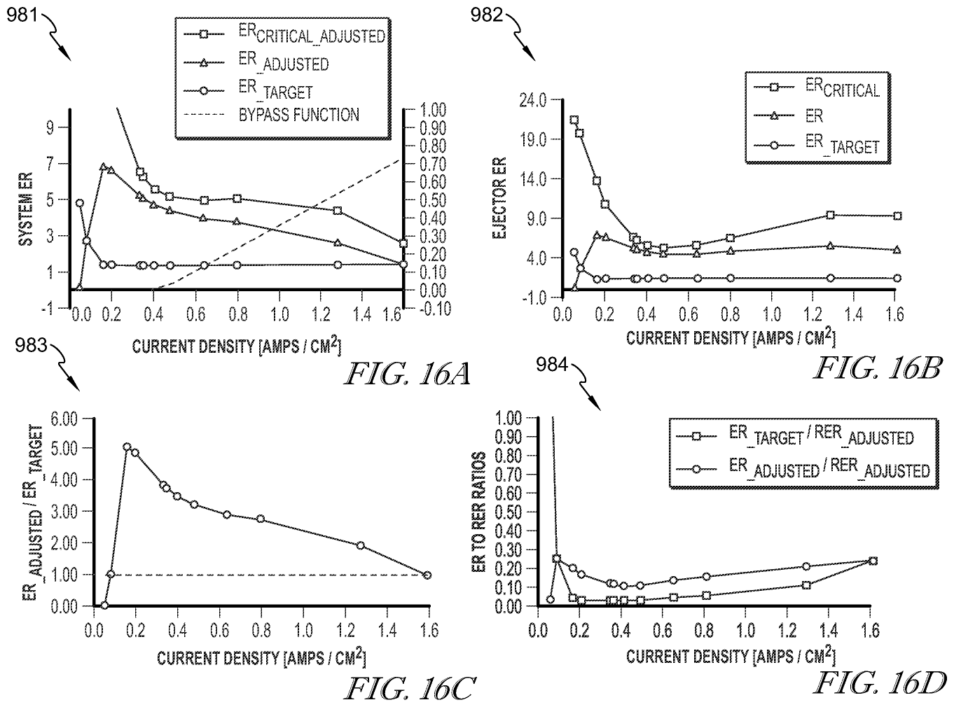

In one embodiment, as shown in graphs 981, 982, 983, 984 in FIGS. 16A-16D, the fuel cell system 10, 11, 13, 15, or 17 may have a maximum pressure lift (ΔP_{LIFT}) of about 0.25 bara, and comprise a venturi or ejector 230 in an EES configuration with an EES size of 0.27, a large mixer area ratio (MAR) value such that geometric restriction may not apply to system (e.g., MAR is about 15), and an ejector efficiency of about 50%. The primary nozzle 236, 630 is sized for the given fraction of the full flow at the rated current of about 0.43 Amps/cm².

The by-pass valve or flow restriction 410 may be set such that flow through the venturi or ejector 230 is maximized i.e., the primary nozzle inlet pressure (P_{O}) is maximized. There may be no flow fraction through the by-pass valve or flow restriction 410. In this configuration, the adjusted entrainment ratio (ER__{adjusted}) may be greater than the target entrainment ratio (ER__{target}) across entire operating range, extending below EES_size (0.27). The adjusted entrainment ratio (ER__{adjusted}) may track the critical adjusted entrainment ratio (ER__{critical_adjusted}). The system may not have any additional motive exergy.

### Example 15

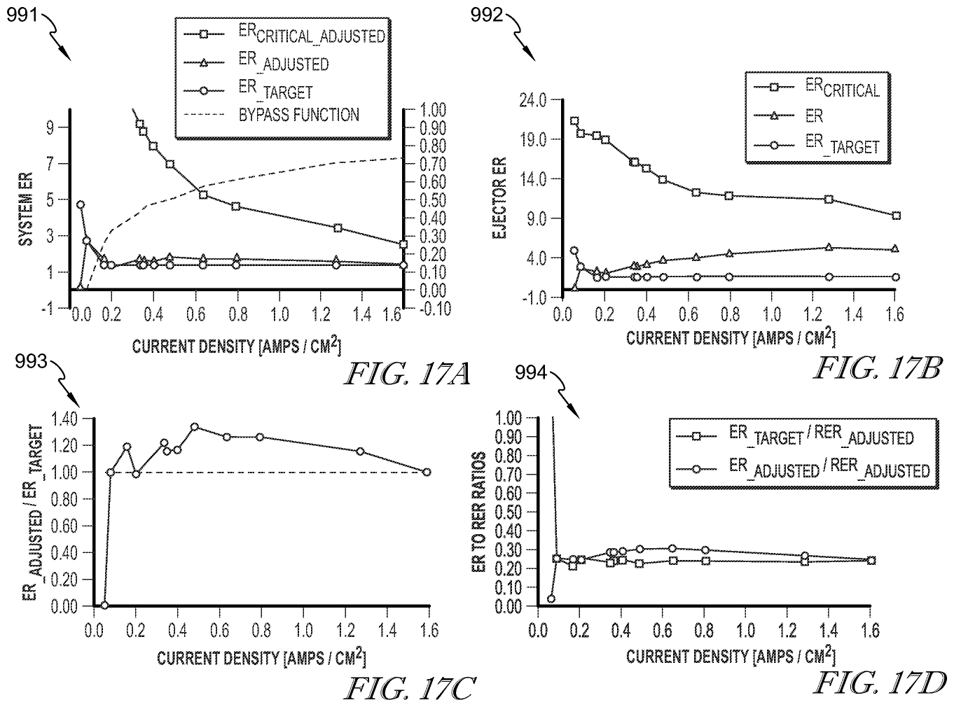

In one embodiment, as shown in graphs 991, 992, 993, 994 in FIGS. 17A-17D, the fuel cell system 10, 11, 13, 15, or 17 may have a maximum pressure lift (ΔP_{LIFT}) of about 0.25 bara, and comprise a venturi or ejector 230 in an EES configuration with an EES size of 0.27, a large mixer area ratio (MAR) value such that geometric restriction may not apply to system (e.g., MAR is about 15), and an ejector efficiency of about 50%. The primary nozzle 236, 630 is sized for the given fraction of the full flow at the rated current of about 0.43 Amps/cm². The by-pass valve or flow restriction 410 may comprise a proportional valve. The by-pass valve flow fraction of the by-pass valve or flow restriction 410 may be adjusted to control adjusted entrainment ratio (ER__{adjusted}) across the operating conditions. The by-pass valve may be fully open at a 100% load conditions and fully closed at idle conditions. In this configuration, the adjusted entrainment ratio (ER__{adjusted}) may track the target entrainment ratio (ER__{target}) across entire operating range.

The following described aspects of the present invention are contemplated and non-limiting:

A first aspect of the present invention relates to a fuel cell or fuel stack system. The fuel cell or fuel stack system includes a first fuel and a second fuel. The first fuel flows through a control valve and a sized ejector. The second fuel flows through a control valve and a by-pass valve. The sized ejector and the by-pass valve are in a parallel configuration.

A second aspect of the present invention relates to a method of using a fuel cell or fuel stack system. The method includes the steps of flowing a first fuel through a sized ejector and flowing a second fuel through a by-pass valve. The sized ejector and the by-pass valve are in a parallel configuration.

In the first and second aspect of the present invention, the by-pass valve may be a proportionally controlled valve.

In the first and second aspect of the present invention, the sized ejector may include a primary nozzle. A size of the sized ejector may be determined by decreasing the primary nozzle area. In the first and second aspect of the present invention, the sized ejector may include a mixer area ratio adjusted to accommodate the second fuel flowing through the by-pass valve. In the first and second aspect of the present invention, the sized ejector may be downsized by a factor of about 4. The mixer area ratio may be increased by a factor of about 2.4 to about 3.8. In the first and second aspect of the present invention, the sized ejector may be downsized by a factor of about 2. The mixer area ratio may be increased by a factor of about 1.4 to about 2.8.

In the first and second aspect of the present invention, the by-pass valve may have a variable opening or closing inner valve that may determine the second fuel flowing through the by-pass valve.

In the first and second aspect of the present invention, the by-pass valve may be sized to allow both the first fuel and the second fuel to flow through the by-pass valve.

In the first and second aspect of the present invention, a size of the sized ejector may be determined based on an effective efficiency of the sized ejector, geometry of the sized ejector or operational conditions of the system. In the first and second aspect of the present invention, the operational conditions of the system may include primary nozzle inlet pressure, secondary inlet pressure, empty pressure of the system, or pressure lift of the system.

In the first and second aspect of the present invention, a size of the sized ejector may be determined based on a composition of the first fuel or a composition of the second fuel.

The features illustrated or described in connection with one exemplary embodiment may be combined with any other feature or element of any other embodiment described herein. Such modifications and variations are intended to be included within the scope of the present disclosure. Further, a person skilled in the art will recognize that terms commonly known to those skilled in the art may be used interchangeably herein.

The above embodiments are described in sufficient detail to enable those skilled in the art to practice what is claimed and it is to be understood that logical, mechanical, and electrical changes may be made without departing from the spirit and scope of the claims. The detailed description is, therefore, not to be taken in a limiting sense.

As used herein, an element or step recited in the singular and proceeded with the word “a” or “an” should be understood as not excluding plural of said elements or steps, unless such exclusion is explicitly stated.

Furthermore, references to “one embodiment” of the presently described subject matter are not intended to be interpreted as excluding the existence of additional embodiments that also incorporate the recited features. Specified numerical ranges of units, measurements, and/or values include, consist essentially or, or consist of all the numerical values, units, measurements, and/or ranges including or within those ranges and/or endpoints, whether those numerical values, units, measurements, and/or ranges are explicitly specified in the present disclosure or not.

Unless defined otherwise, technical and scientific terms used herein have the same meaning as is commonly understood by one of ordinary skill in the art to which this disclosure belongs. The terms “first”, “second”, “third”, and the like, as used herein do not denote any order or importance, but rather are used to distinguish one element from another. The term “or” and “and/or” is meant to be inclusive and mean either or all of the listed items. In addition, the terms “connected” and “coupled” are not restricted to physical or mechanical connections or couplings, and can include electrical connections or couplings, whether direct or indirect.

Moreover, unless explicitly stated to the contrary, embodiments “comprising”, “including”, or “having” an element or a plurality of elements having a particular property may include additional such elements not having that property. The term “comprising” or “comprises” refers to a composition, compound, formulation, or method that is inclusive and does not exclude additional elements, components, and/or method steps. The term “comprising” also refers to a composition, compound, formulation, or method embodiment of the present disclosure that is inclusive and does not exclude additional elements, components, or method steps. The phrase “consisting of” or “consists of” refers to a compound, composition, formulation, or method that excludes the presence of any additional elements, components, or method steps.

The term “consisting of” also refers to a compound, composition, formulation, or method of the present disclosure that excludes the presence of any additional elements, components, or method steps. The phrase “consisting essentially of” or “consists essentially of” refers to a composition, compound, formulation, or method that is inclusive of additional elements, components, or method steps that do not materially affect the characteristic(s) of the composition, compound, formulation, or method. The phrase “consisting essentially of” also refers to a composition, compound, formulation, or method of the present disclosure that is inclusive of additional elements, components, or method steps that do not materially affect the characteristic(s) of the composition, compound, formulation, or method steps.

Approximating language, as used herein throughout the specification and claims, may be applied to modify any quantitative representation that could permissibly vary without resulting in a change in the basic function to which it is related. Accordingly, a value modified by a term or terms, such as “about”, and “substantially” is not to be limited to the precise value specified. In some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

It is to be understood that the above description is intended to be illustrative, and not restrictive. For example, the above-described embodiments (and/or aspects thereof) may be used individually, together, or in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A fuel cell or fuel stack system comprising:
a first fuel flowing through a control valve and a sized ejector, and
a second fuel flowing through a control valve and a by-pass valve,
wherein the sized ejector and the by-pass valve are in a parallel configuration.

2. The system of claim 1, wherein the by-pass valve is a proportionally controlled valve.

3. The system of claim 1, wherein the sized ejector comprises a primary nozzle and a size of the sized ejector is determined by decreasing a primary nozzle area.

4. The system of claim 3, wherein the sized ejector comprises a mixer area ratio adjusted to accommodate the second fuel flowing through the by-pass valve.

5. The system of claim 4, wherein the sized ejector is downsized by a factor of about 4 and the mixer area ratio in increased by a factor of about 2.4 to about 3.8

6. The system of claim 4, wherein the sized ejector is downsized by a factor of about 2 and the mixer area ratio in increased by a factor of about 1.4 to about 2.8.

7. The system of claim 1, wherein the by-pass valve has a variable opening or a closing inner valve that can determine the second fuel flowing through the by-pass valve.

8. The system of claim 1, wherein the by-pass valve is sized to allow both the first fuel and the second fuel to flow through the by-pass valve.

9. The system of claim 1, wherein a size of the sized ejector is determined based on an effective efficiency of the sized ejector, geometry of the sized ejector or operational conditions of the system.

10. The system of claim 9, wherein the operational conditions of the system comprise primary nozzle inlet pressure, secondary inlet pressure, empty pressure of the system, or pressure lift of the system.

11. The system of claim 1, wherein a size of the sized ejector is determined based on a composition of the first fuel or a composition of the second fuel.

12. A method of using a fuel cell or fuel stack system comprising:
flowing a first fuel through a sized ejector,
flowing a second fuel through a by-pass valve,
wherein the sized ejector and the by-pass valve are in a parallel configuration.

13. The method of claim 12, wherein the by-pass valve is a proportionally controlled valve.

14. The method of claim 12, wherein the sized ejector comprises a primary nozzle and a size of the sized ejector is determined by decreasing the primary nozzle area.

15. The method of claim 14, wherein the sized ejector comprises a mixer area ratio that is adjusted to accommodate the second fuel flowing through the by-pass valve.

16. The method of claim 12, wherein the by-pass valve has a variable opening or closing inner valve that can determine the second fuel flowing through the by-pass valve.

17. The method of claim 12, wherein the by-pass valve is sized to allow both the first fuel and second fuel to flow through the by-pass valve.

18. The method of claim 12, wherein a size of the sized ejector is determined based on an effective efficiency of the sized ejector, geometry of the sized ejector, or operational conditions of the system.

19. The method of claim 18, wherein the operational conditions of the system comprise a primary nozzle inlet pressure, a secondary inlet pressure, or a pressure lift of the system.

20. The method of claim 12, wherein a size of the sized ejector is determined based on a composition of the first fuel or a composition of the second fuel.
